(19) United States
(12) Patent Application Publication
(10) Pub. No.: US 2013/0214871 A1
(43) Pub. Date: Aug. 22, 2013

(54) WAVEGUIDE CONVERTER

(71) Applicant: FUJITSU LIMITED, (US)

(72) Inventors: Satoshi NAKAMURA, Oyama (JP); Yoji Ohashi, Fucyu (JP); Toshihiro Shimura, Yokohama (JP); Takenori Ohshima, Isehara (JP); Keiichi Oguro, Yokohama (JP)

(73) Assignee: FUJITSU LIMITED, Kawasaki-shi (JP)

(21) Appl. No.: 13/767,939

(22) Filed: Feb. 15, 2013

(30) Foreign Application Priority Data
Feb. 20, 2012 (JP) 2012-034062

(51) Int. Cl. H01P 5/107

(52) U.S. Cl. CPC H01P 1/16
USPC 333/26

(57) ABSTRACT

A waveguide converter includes a waveguide including a hollow section through which a signal is transmitted and a first opening formed on a cross section of the hollow section in a direction orthogonal to a transmission direction of the signal, and a circuit board including on a same surface a signal line, a conductor patch connected to the signal line, and a second opening surrounding the conductor patch. The waveguide is fixed onto the circuit board. The first opening surrounds the second opening. The conductor patch includes a rectangular section which has short sides in parallel with short sides of the first opening, and has a first long side and a second long side connected to the signal line in parallel with long sides of the first opening, and protruding portions which are provided so as to touch the short sides near both ends of the second long side, respectively.

### CROSS-REFERENCE TO RELATED APPLICATIONS

This application is based upon and claims the benefit of priority of the prior Japanese Patent Application No. 2012-034062, filed on Feb. 20, 2012, the entire contents of which are incorporated herein by reference.

### FIELD

The embodiments discussed herein are related to a waveguide converter that converts the transmission mode of a signal between a wave guide and a transmission line of a circuit board.

### BACKGROUND

When a signal whose band has a short wavelength, such as millimeter waves or microwaves, which is typically used for car radar and high-seed wireless communication system, is transmitted from and received at an antenna by using a transmitter-receiver circuit, a waveguide may be connected between the transmitter-receiver circuit and the antenna.

The transmitter-receiver circuit is integrated, for example, as a monolithic microwave integrated circuit (MMIC), and a planar transmission line such as a microstrip line and a coplanar line is used for a transmission line on the transmitter-receiver circuit side. The transmission mode of a signal is different between such a transmission line on a transmitter-receiver circuit side and a waveguide. Thus, when a waveguide is connected between a transmitter-receiver circuit and an antenna, a waveguide converter is used to convert the transmission mode so as to be suitable for the transmission line on a transmitter-receiver circuit side and the waveguide, respectively.

In regard to waveguide converters, the following related art is known. That is, a microstrip line—waveguide converter is comprised of a waveguide, a first conductor layer, a dielectric substrate, and a ground conductor layer. The first conductor layer is comprised of a microstrip line that has a patch pattern formed on an end, a ground conductor pattern that surrounds the patch pattern, and via holes that connect the ground conductor pattern and the ground conductor layer. Then, the waveguide, the first conductor layer, the dielectric substrate, and the ground conductor layer are stacked from the top in the listed order at a position where the center of the opening of a waveguide and the center of the patch pattern overlap with each other. A number of via holes are formed so as to surround the periphery of the opening of the waveguide.

Moreover, the following related art is also known. That is, a waveguide/strip line converter is provided with: a dielectric substrate having a first surface that closes the rectangular opening of a waveguide; a shorting plate formed on a second surface of a dielectric substrate to short the waveguide; a matching element formed on a first surface of the dielectric substrate; and a strip line that is formed in an incision of the shorting plate and is electromagnetically coupled to the matching element. The matching element is shaped so as to surround a non-formation area, and has an asymmetrical shape with reference to a direction parallel to the long sides of the opening.

Furthermore, the following related art is also known. That is, a waveguide/strip line converter is comprised of a rectangular waveguide and a dielectric substrate. An aperture for guiding an electromagnetic wave is arranged on one end of the rectangular waveguide, and an end surface is arranged on the other end. The dielectric substrate is inserted into the rectangular waveguide from the side of the dielectric substrate in such a manner that the dielectric substrate exists in a direction orthogonal to the end surface of the rectangular waveguide and the mounted position viewed from the opening is at approximately the center of the aperture. Moreover, an approximately cross-shaped conductor pattern is arranged on the dielectric substrate, and one side of the conductor pattern is extended as a pattern to draw out a signal to the outside of the rectangular waveguide. The pattern to draw out a signal is formed as a strip line outside the rectangular waveguide. The electric field of an electromagnetic wave that is guided into the rectangular waveguide is coupled to the conductor pattern, and is converted to an electric signal by the conductor pattern and transmitted to the strip line.

The waveguide converter includes a conductor patch. The conductor patch has the function of emitting a signal that is transmitted through the transmission line on a transmitter-receiver circuit side to the waveguide, and has the function of emitting a signal that is transmitted through the waveguide to the transmission line on the transmitter-receiver circuit side.

It is necessary for the size of the conductor patch to be smaller than the opening of a waveguide that is determined according to an active frequency band. In order for the waveguide converter to achieve a good signal conversion performance in a desired frequency band, it is necessary to determine the shape and size of the conductor patch according to the wavelength of a signal determined by the dielectric constant or the like of the dielectric substrate that composes the transmission line on the transmitter-receiver circuit side.

When a rectangular-shaped conductor patch is provided for a waveguide converter, the waveguide converter may perform signal conversion in a desired active frequency if the length of sides of the conductor patch that is parallel with the transmission direction of a signal of the transmission line on the transmitter-receiver circuit side are set to be half the wavelength of the signal. However, half the wavelength of a signal that is transmitted through the dielectric substrate may be greater than the short sides of the opening of the waveguide when, for example, a low-level side of a recommended frequency band of the waveguide is used or when, for example, a dielectric substrate of a low dielectric constant is used. In order to achieve a good signal conversion performance in such a case by using a rectangular-shaped conductor patch, it is necessary for the shape of a conductor patch to be rectangular and longer in a direction of the long sides of the opening of the waveguide. However, depending on the length of the long sides of a conductor patch, a resonance that degrades the pass characteristic of a signal between the waveguide and the transmission line is caused near the active frequency band. For this reason, it is necessary to design the waveguide converter such that a resonance frequency that degrades the pass characteristic of the waveguide converter will not be caused near the active frequency band.

Moreover, when a resin whose pattern precision is poor is used, for example for the purpose of cost reduction, as a substrate material instead of ceramics, a pattern misalignment may be caused when a waveguide converter is manufactured.

FIG. 1 depicts the deterioration of a pass characteristic caused due to a pattern misalignment.

In FIG. 1, pass characteristics T1 and T2 of a waveguide converter are depicted with a scattering parameter S21 where a port 1 is on a waveguide side and a port 2 is on a transmission line side to which a transmitter-receiver circuit is connected.

As illustrated in FIG. 1, the pass characteristic T2 where pattern misalignment was caused when the waveguide converter was manufactured deteriorates at the center frequency of an active frequency band f_{c} in comparison with the pass characteristic T1 where no pattern misalignment was caused. A resonance frequency fᵣ₂ that degrades the pass characteristic T2 is closer to the center frequency of an active frequency band f_{c} in comparison with a resonance frequency fᵣ₁ that degrades the pass characteristic T1.

As described above, when a pass characteristic deteriorates at the center frequency of an active frequency band due to the pattern misalignment that was caused when the waveguide was manufactured, or when a resonance frequency that degrades the pass characteristic is misaligned and gets close to an active frequency band, a signal conversion performance of the waveguide converter deteriorates. Thus, it is necessary to design a waveguide converter in such a manner that the deterioration of a pass characteristic will be minimized and a required signal conversion performance will be secured even if the pattern precision of the waveguide converter at the time of manufacture is poor.

### RELATED ART DOCUMENT

### Patent Documents

[Patent Document 1]
Japanese Laid-open Patent Publication No. 2011-061290
[Patent Document 2]
Japanese Laid-open Patent Publication No. 2010-087651
[Patent Document 3]
Japanese Laid-open Patent Publication No. 05-090806

### SUMMARY

According to an aspect of the embodiments, a waveguide converter includes a waveguide which includes a hollow section through which a signal is transmitted and a first opening formed on a cross section of the hollow section in a direction orthogonal to a transmission direction of the signal, and a circuit board which includes on a same surface a signal line, a conductor patch connected to the signal line, and a second opening surrounding the conductor patch. The waveguide is adhered and fixed onto the circuit board in such a manner that the first opening surrounds the second opening. The conductor patch includes a rectangular section and protruding portions. The rectangular section has short sides in a direction parallel to short sides of the first opening, and has a first long side and a second long side in a direction parallel to long sides of the first opening. The second long side is connected to the signal line. The protruding portions are provided so as to touch the short sides near both ends of the second long side, respectively.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts the deterioration of a pass characteristic caused by a pattern misalignment;

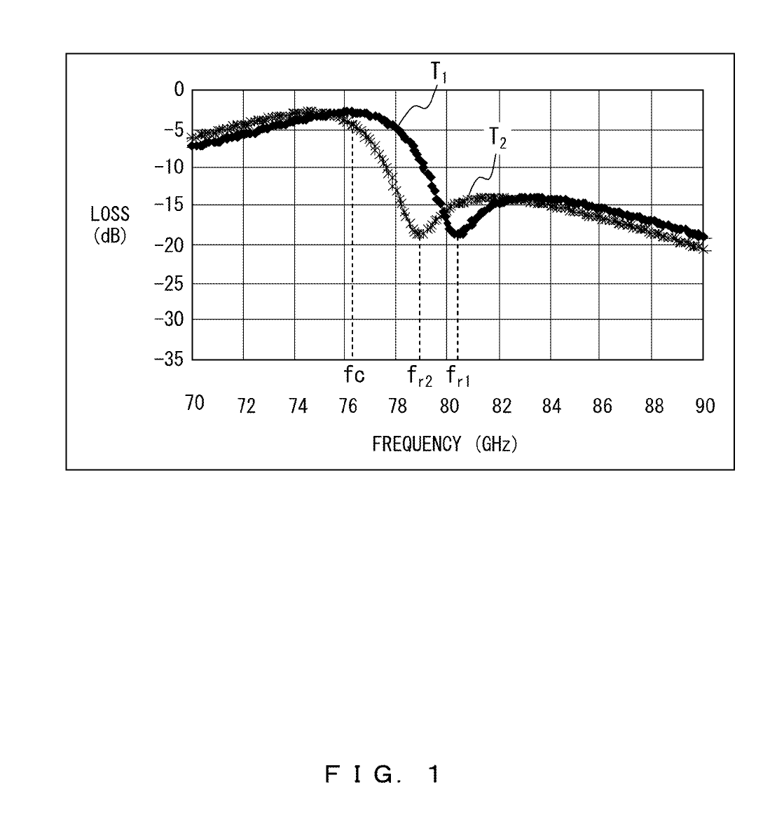

FIG. 2 is a perspective view of an example of the waveguide converter according to the first embodiment;

FIG. 3 is a top view of an example of the waveguide converter according to the first embodiment;

FIG. 4 is a drawing explaining the relationship between the shape of a rectangular patch and a frequency characteristic;

FIG. 5 is a drawing explaining the relationship between the shape of a conductor patch according to the first embodiment and a frequency characteristic;

FIG. 6 is a perspective view of a simulation model of a waveguide converter that is provided with a rectangular patch;

FIG. 7 is a top view of a simulation model of a waveguide converter that is provided with a rectangular patch;

FIG. 8 is a list of the sizes of a rectangular patch for which a simulation analysis is performed;

FIG. 9 depicts the relationship between the length L of the rectangular patch and a resonance frequency of the pass characteristic or a resonance frequency of the reflection characteristic;

FIG. 10 depicts the relationship between the length L of the rectangular patch and the band of reflection characteristic where the loss becomes −10 (dB);

FIG. 11 is a perspective view of a simulation model of a waveguide converter that is provided with the conductor patch according to the first embodiment;

FIG. 12 is a top view of a simulation model of a waveguide converter that is provided with the conductor patch according to the first embodiment;

FIG. 13 depicts the relationship between Y₁ and a resonance frequency of the pass characteristic or a resonance frequency of the reflection characteristic when Y, X, and X₁ of the conductor patch according to the first embodiment are fixed and Y₁ is varied;

FIG. 14 depicts the relationship between Y₁ and the band of reflection characteristic where the loss becomes −10 (dB) when Y, X, and X₁ of the conductor patch according to the first embodiment are fixed and Y₁ is varied;

FIG. 15 depicts the relationship between X₁ and a resonance frequency of the pass characteristic or a resonance frequency of the reflection characteristic when Y, X, and Y₁ of the conductor patch according to the first embodiment are fixed and X₁ is varied;

FIG. 16 depicts the relationship between X₁ and the band of reflection characteristic where the loss becomes −10 (dB) when Y, X, and Y₁ of the conductor patch according to the first embodiment are fixed and X₁ is varied;

FIG. 17 depicts the relationship between X₁ and a resonance frequency of the pass characteristic or a resonance frequency of the reflection characteristic when Y, Y₁, and X′ of the conductor patch according to the first embodiment are fixed and X and X₁ are varied;

FIG. 18 depicts the relationship between X₁ and the band of reflection characteristic where the loss becomes −10 (dB) when Y, Y₁, and X′ of the conductor patch according to the first embodiment are fixed and X and X₁ are varied;

FIG. 19 is a list of the sizes of the conductor patch according to the first embodiment for which a simulation analysis is performed by fixing X′ and increasing X₁, Y₁, X, and Y;

FIG. 20 depicts a reflection characteristic S11 in cases where X′ of the conductor patch according to the first embodiment is fixed and the values of X₁ and Y₁ are increased;

FIG. 21 depicts a reflection characteristic S22 in cases where X′ of the conductor patch according to the first embodiment is fixed and the values of X₁ and Y₁ are increased;

FIG. 22 depicts a pass characteristic S21 in cases where X′ of the conductor patch according to the first embodiment is fixed and the values of X₁ and Y₁ are increased;

FIG. 23 depicts the relationship between L′ and a resonance frequency of the pass characteristic or a resonance frequency of the reflection characteristic when X′ is fixed and X₁, Y₁, X, and Y are increased;

FIG. 24 depicts the relationship between L′ and the frequency band of reflection characteristic where the loss becomes −10 (dB) when X′ is fixed and X₁, Y₁, X, and Y are increased;

FIG. 25 depicts an electric field intensity distribution of the pass characteristic S21 in the resonance frequency of a rectangular conductor patch;

FIG. 26 depicts an electric field intensity distribution of the pass characteristic S21 in the resonance frequency of a conductor patch according to the first embodiment;

FIG. 27 is a perspective view of an example of the waveguide converter according to the second embodiment;

FIG. 28 is a top view of an example of the waveguide converter according to the second embodiment;

FIG. 29 is a drawing for explaining the relationship between the shape of a conductor patch according to the second embodiment and a frequency characteristic;

FIG. 30 depicts a simulation result of the reflection characteristic S11 of the waveguide converter that includes the conductor patch according to the second embodiment or the waveguide converter that includes a rectangular patch;

FIG. 31 depicts a simulation result of the reflection characteristic S22 of the waveguide converter that includes the conductor patch according to the second embodiment or the waveguide converter that includes a rectangular patch; and

FIG. 32 depicts a simulation result of the pass characteristic S21 of the waveguide converter that includes the conductor patch according to the second embodiment or the waveguide converter that includes a rectangular patch.

### DESCRIPTION OF EMBODIMENTS

Some embodiments of the present invention will be described in detail with reference to the accompanying drawings.

### First Embodiment

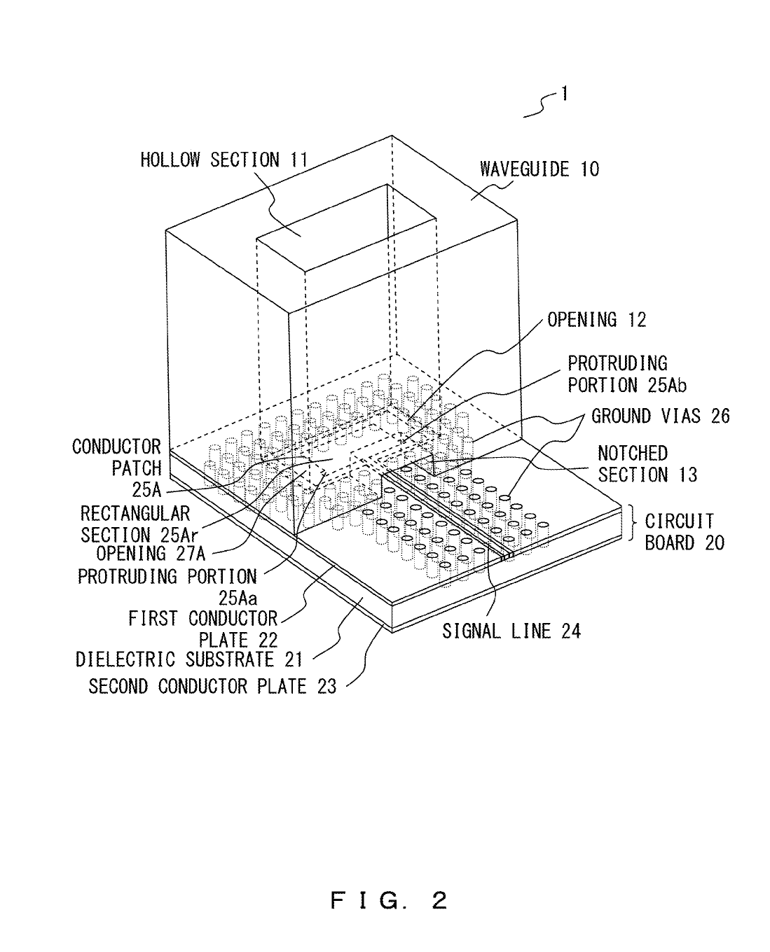

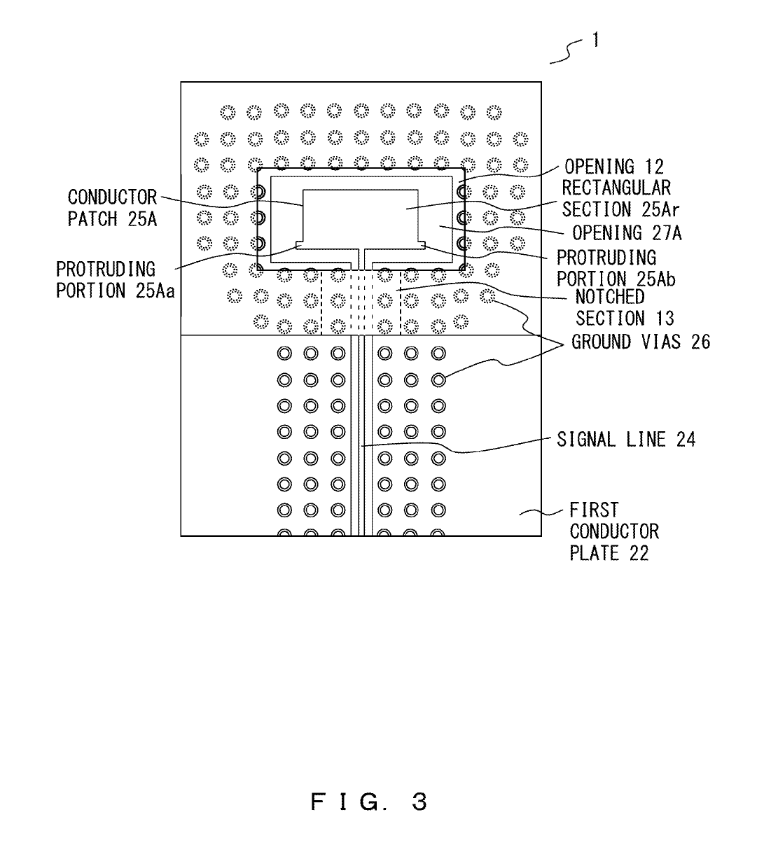

FIG. 2 is a perspective view of an example of the waveguide converter according to the first embodiment. FIG. 3 is a top view of an example of the waveguide converter according to the first embodiment.

As illustrated in FIG. 2, the waveguide converter 1 according to the first embodiment includes a waveguide 10 and a circuit board 20.

The waveguide 10 is a transmission line that transmits a signal (radio wave), and is disposed on the top surface of the circuit board 20 as illustrated in FIG. 2.

As illustrated in FIG. 2, the waveguide 10 includes a hollow section 11 in a square-tube shape surrounded by the conducting wall that constitutes the waveguide 10, and a signal is transmitted through the hollow section 11.

Moreover, an opening 12 is provided on one end of the waveguide 10 in the transmission direction of a signal. The opening 12 is formed by a cross section of the hollow section 11 in the direction orthogonal to the transmission direction of a signal. Note that an antenna (not illustrated) that emits and receives a high-frequency signal such as microwaves and millimeter waves may be connected to the other ends of the waveguide 10 at which the opening 12 does not exist.

The circuit board 20 includes a dielectric substrate 21, a first conductor plate 22, a second conductor plate 23, a signal line 24, a conductor patch 25A, and ground vias 26.

As illustrated in FIG. 2, the first conductor plate 22, the signal line 24, and the conductor patch 25A are provided on the top surface of the dielectric substrate 21. In other words, the first conductor plate 22, the signal line 24, and the conductor patch 25A are disposed on the same surface of the dielectric substrate 21. Moreover, the second conductor plate 23 is disposed on the undersurface of the dielectric substrate 21.

The signal line 24 is a transmission line provided for the circuit board 20, and is, for example, a microstrip line. As illustrated in FIG. 3, a certain distance of insulation space is provided between the first conductor plate 22 and the signal line 24, and a coplanar line is formed by the first conductor plate 22 and the signal line 24.

As illustrated in FIG. 2, a notched section 13 is provided on a side of the waveguide 10 at one end where the opening 12 is formed, and the signal line 24 within the opening 12 is drawn out from the waveguide 10 through the notched section 13.

The notched section 13 is shaped like a rectangular parallelepiped, and the undersurface of the notched section 13 touches the top surface of the first conductor plate 22. The width and height of the aperture plane of the notched section 13 in the direction in which the signal line 24 is drawn out from the waveguide 10 is set sufficiently smaller than half the wavelength calculated from the active frequency of a signal.

As illustrated in FIG. 3, an opening 27A that exposes the dielectric substrate 21 is provided on the first conductor plate 22. The shape of the outer edge of the opening 27A is similar to the shape of the edge of the opening 12, and the size of the opening 27A is smaller than the size of the opening 12. The end of the waveguide 10 that has the opening 12 is adhered and fixed onto the first conductor plate 22 in such a manner that the opening 12 surrounds the opening 27A.

Inside the opening 27A, the conductor patch 25A is provided with space so as to not be electrically continuous with the first conductor plate 22. As illustrated in FIG. 2, the conductor patch 25A is formed on the surface of the dielectric substrate 21 on which the signal line 24 is also formed, and the conductor patch 25A is connected to one end of the signal line 24.

Note that a transmitter-receiver circuit (not illustrated) of a high-frequency signal such as microwaves and millimeter waves may be connected to the other end of the signal line 24 that is not connected to the conductor patch 25A. Such a transmitter-receiver circuit may be integrated as a monolithic microwave integrated circuit.

As illustrated in FIG. 2 and FIG. 3, the conductor patch 25A according to the first embodiment includes a rectangular section 25Ar and protruding portions 25Aa and 25Ab.

The rectangular section 25Ar is a part of the conductor patch 25A, and is a rectangular-shaped portion of the conductor patch 25A. The protruding portions 25Aa and 25Ab are parts of the conductor patch 25A, and are protruding portions of the conductor patch 25A.

As illustrated in FIG. 2 and FIG. 3, the rectangular section 25Ar has short sides in the direction parallel with the transmission direction of a signal on the signal line 24, and has long sides in the direction orthogonal to the transmission direction of that signal. In other words, the rectangular section 25Ar has short sides in the same direction as that of the short sides of the hollow section 11 of the waveguide 10, and has long sides in the same direction as that of the long sides of the hollow section 11.

As illustrated in FIG. 2 and FIG. 3, the protruding portions 25Aa and 25Ab are provided on the short sides of the rectangular section 25Ar near both ends of the long side of the rectangular section 25Ar which is connected to the signal line 24.

The protruding portions 25Aa and 25Ab having a rectangular shape are depicted in FIG. 2 and FIG. 3, but the protruding portions 25Aa and 25Ab may be squares or rectangles. Moreover, the shape of the protruding portions 25Aa and 25Ab may be polygonal or circular instead of being rectangular.

When the protruding portions 25Aa and 25Ab are rectangular-shaped as illustrated in FIG. 2 and FIG. 3, sides of the protruding portions 25Aa and 25Ab exist in parallel with the short sides of the rectangular section 25Ar. Moreover, sides of the protruding portions 25Aa and 25Ab exist on the extension of the long side of the rectangular section 25Ar that is connected to the signal line 24, and the long side of the rectangular section 25Ar and these sides of the protruding portions 25Aa and 25Ab form a side of the conductor patch 25A that is connected to the signal line 24.

As illustrated in FIG. 3, the conductor patch 25A may be arranged in such a manner that a center line that vertically divides the long sides of the rectangular section 25Ar into two equal parts matches a center line that vertically divides the long sides of the opening 12 of the waveguide 10 into two equal parts. Moreover, the conductor patch 25A may be arranged in such a manner that the signal line 24 is connected onto a center line that vertically divides the long sides of the rectangular section 25Ar into two equal parts.

The ground vias 26 are coupling parts that electrically couple the first conductor plate 22 to the second conductor plate 23. As illustrated in FIG. 2 and FIG. 3, the ground vias 26 are formed under one end of the waveguide 10 that is adhered and fixed onto the first conductor plate 22, and are formed under the first conductor plate 22 that surrounds the signal line 24. The ground vias 26 are not formed under the signal line 24.

A method for determining the shape and size of the conductor patch 25A according to the first embodiment will be explained.

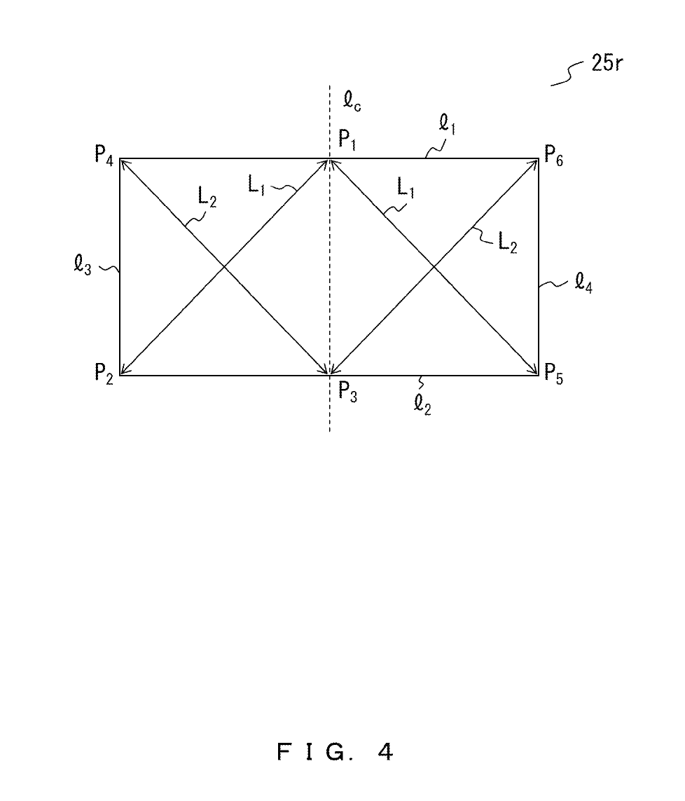

FIG. 4 is a drawing for explaining the relationship between the shape of a rectangular patch and a frequency characteristic.

A rectangular conductor patch 25r of FIG. 4 includes long sides l₁ and l₂, and short sides l₃ and l₄.

Here, it is assumed that the conductor patch 25r is provided as the conductor patch of the waveguide converter 1, instead of the conductor patch 25A including the protruding portions 25Aa and 25Ab. In other words, it is assumed that the conductor patch 25r is arranged within the opening 12 of the waveguide 10 such that the long side l₁ and l₂ will be parallel with the long sides of the waveguide 10 and the short sides l₃ and l₄ will be parallel with the short sides of the waveguide 10, and that the signal line 24 is connected to the long side l₂ which is illustrated at the bottom of FIG. 4. In this case, the relationship between the shape of the conductor patch 25r and a frequency characteristic is explained as below.

Firstly, an undesired resonance frequency in the waveguide converter that includes the conductor patch 25r, i.e., a resonance frequency that degrades the pass characteristic indicated by a scattering parameter S21 when it is assumed that a port 1 exists on the waveguide 10 side and a port 2 exists on the signal line 24 side, is determined according to the length of a straight line L₁ illustrated in FIG. 4.

The straight line L₁ is a straight line that is drawn from a point P₁ at which a center line l_{c} that vertically divides the long sides l₁ and l₂ of the conductor patch 25r into two equal parts intersects with a long side l₁ at the top of FIG. 4 to a point P₂ at which a long side l₂ at the bottom of FIG. 4 intersects with a short side l₃. Also, the straight line L₁ is a straight line that is drawn from the intersection point P₁ to a point P₅ at which the long side l₂ at the bottom of FIG. 4 intersects with a short side l₄.

Next, the center frequency of an active frequency band in the waveguide converter that includes the conductor patch 25r, i.e., a resonance frequency that degrades the reflection characteristic indicated by scattering parameters S11 and S22, is determined according to the length of a straight line L₂.

The straight line L₂ is a straight line that is drawn from a point P₃ at which the center line l_{c} intersects with the long side l₂ at the bottom of FIG. 4 to a point P₄ at which the long side l₁ at the top of FIG. 4 intersects with the short side l₃. Also, the straight line L₂ is a straight line that is drawn from the intersection point P₃ to a point P₆ at which the long side l₁ at the top of FIG. 4 intersects with the short side l₄.

The size of the rectangular conductor patch 25r and an undesired resonance frequency or an active center frequency are in a relationship such as that above. For this reason, when the length of the straight line L₁ is the same as the length of the straight line L₂ as in the conductor patch 25r of FIG. 4 for example, an undesired resonance frequency becomes close to the center frequency of an active frequency band. When an undesired resonance frequency becomes close to the center frequency of an active frequency band, the signal conversion performance of the waveguide deteriorates.

Hence, in the first embodiment, the conductor patch 25A includes the rectangular section 25Ar and the protruding portions 25Aa and 25Ab as illustrated in FIGS. 2, 3, and 5 in order to keep an undesired resonance frequency away from the center frequency of an active frequency band.

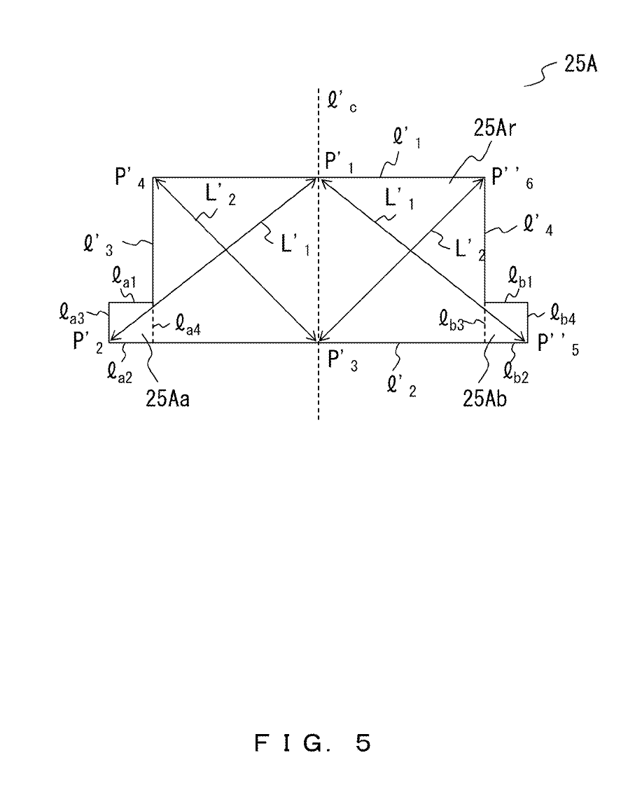

FIG. 5 is a drawing for explaining the relationship between the shape of a conductor patch according to the first embodiment and a frequency characteristic.

In FIG. 5, the signal line 24 is connected to the long side l₂′ side of the rectangular section 25Ar at the bottom of FIG. 5, and the conductor patch 25A is arranged within the opening 12 of the waveguide 10.

The rectangular section 25Ar is provided with long sides l₁′ and l₂′ and short sides l₃′ and l₄′. The long sides l₁′ and l₂′ are parallel with the long sides of the waveguide 10, and the short sides l₃′ and l₄′ are parallel with the short sides of the waveguide 10.

The protruding portion 25Aa includes sides lₐ₁-lₐ₄. The side lₐ₁ is parallel with the side lₐ₂, and the side lₐ₃ is parallel with the side lₐ₄. The protruding portion 25Ab includes sides l_{b1}-l_{b4}. The side l_{b1} is parallel with the side l_{b2}, and the side l_{b3} is parallel with the side l_{b4}.

The protruding portions 25Aa and 25Ab are arranged so as to touch the short sides of the rectangular section 25Ar near both ends of the long side l₂′ that is connected to the signal line 24. In other words, the protruding portion 25Aa is arranged so as to touch one end of the long side l₂′, where the side lₐ₄ overlaps with the short side l₃′. Also, the protruding portion 25Ab is arranged so as to touch one end of the long side l₂′, where the side l_{b3} overlaps with the short side l₄′.

The side lₐ₃ of the protruding portion 25Aa and the side l_{b4} of the protruding portion 25Ab exist in parallel with the short sides l₃′ and l₄′ of the rectangular section 25Ar. The side lₐ₂ of the protruding portion 25Aa and the side l_{b2} of the protruding portion 25Ab exist on the extension of the long side l₂′ of the rectangular section 25Ar, and the long side l₂′ as well as side lₐ₂ and side l_{b2} form the long side, which connects to the signal line 24, of the conductor patch 25A.

Firstly, an undesired resonance frequency in the waveguide converter 1 that includes the conductor patch 25A of FIG. 5, i.e., a resonance frequency that degrades the pass characteristic indicated by the scattering parameter S21 when it is assumed that a port 1 exists on the waveguide 10 side and a port 2 exists on the signal line 24 side, is determined according to the length of a straight line L₁′ illustrated in FIG. 5.

The straight line L₁′ is a straight line that is drawn from a point P₁′ at which a center line l_{c}′ that vertically divides the long sides l₁′ and l₂′ of the rectangular section 25Ar into two equal parts intersects with the long side l₁′ at the bottom of FIG. 5 to a point P₂′ at which a side lₐ₃ of the protruding portion 25Aa that is parallel with the short side l₃′ and that does not touch the rectangular section 25Ar intersects with a side lₐ₂ of the protruding portion 25Aa on the extension of the long side l₂′. Also, the straight line L₁′ is a straight line that is drawn from the intersection point P₁′ to a point P₅′ at which a side l_{b4} of the protruding portion 25Ab that is parallel with the short side l₄′ and that does not touch the rectangular section 25Ar intersects with a side l_{b2} of the protruding portion 25Ab on the extension of the long side l₂′.

Next, the center frequency of an active frequency band in the waveguide converter 1 that includes the conductor patch 25A, i.e., a resonance frequency that degrades the reflection characteristic indicated by scattering parameters S11 and S22, is determined according to the length of a straight line L₂′.

The straight line L₂′ is a straight line that is drawn from a point P₃′ at which the center line l_{c}′ intersects with the long side l₂′ at the bottom of FIG. 5 to a point P₄′ at which the long side l₁′ at the top of FIG. 5 intersects with the short side l₃′. Also, the straight line L₂′ is a straight line that is drawn from the intersection point P₃′ to a point P₆′ at which the long side l₁′ at the top of FIG. 5 intersects with the short side l₄′.

As illustrated in FIG. 5, the protruding portion 25Aa is provided for the conductor patch 25A according to the first embodiment so as to touch the short side l₃′ at one end of the long side l₂′. Moreover, the protruding portion 25Ab is provided for the conductor patch 25A so as to touch the short side l₄′ at the other end of the long side l₂′. Accordingly, it becomes possible to make the straight line L′ that determines an undesired resonance frequency be longer than the straight line L2′ that determines the center frequency of an active frequency band due to the existence of the protruding portions 25Aa and 25Ab. When the straight line L₁′ is made longer than the straight line L₂′, it is possible to shift an undesired resonance frequency to a high frequency, and thus it becomes possible to keep an undesired resonance frequency away from the center frequency of an active frequency band.

Accordingly, the waveguide converter 1 that is provided with the conductor patch 25A according to the first embodiment may achieve a good signal conversion performance in an active frequency band. Moreover, it is possible to secure a good signal conversion performance in the active frequency band even if a pattern misalignment is caused when a waveguide converter is manufactured because it is possible to keep an undesired resonance frequency away from the center frequency of an active frequency band.

Furthermore, the conductor patch 25A according to the first embodiment is formed in such a manner that the length of the short sides and long sides of the rectangular section 25r excluding the protruding portions 25Aa and 25Ab becomes shorter than the length of the short sides and long sides of the conductor patch 25r of FIG. 4. In other words, when the center frequency of an active frequency band is the same between the waveguide converter 1 provided with the conductor patch 25A and the waveguide converter provided with the conductor patch 25r, the long sides l₁′ and l₂′ are shorter than the long sides l₁ and l₂, the short sides l₃′ and l₄′ are shorter than the short sides l₃ and l₄, and the size of the rectangular section 25Ar is smaller than the size of the conductor patch 25r. The center frequency of an active frequency band is moved as the shape of a conductor patch becomes no longer rectangular due to the provision of the protruding portions 25Aa and 25Ab, and thus it becomes necessary to adjust the length of L₂′. For this reason, the size of the conductor patch 25A is smaller than the size of the conductor patch 25r as described above.

An example of the method for determining the shape and size of the conductor patch 25A according to the first embodiment by using an electromagnetic field simulation will be described below. It will be described below that the waveguide converter 1 provided with the conductor patch 25A according to the first embodiment has a good signal conversion performance in comparison with the waveguide converter that includes the rectangular conductor patch 25r as illustrated in FIG. 4.

Note that the example described below is only for explaining a method of determining the shape and size of the conductor patch 25A and demonstrating an advantageous effect of the waveguide converter 1 that is provided with the conductor patch 25A. In other words, a method for determining the shape and size of the conductor patch 25A and an advantageous effect of the waveguide converter 1 are not limited to the specific numeric values described in the example below.

Firstly, a result of the simulation analysis of a signal conversion performance in the case where the rectangular conductor patch 25r is provided for the waveguide converter 1 instead of the conductor patch 25A will be described in comparison with a signal conversion performance in the case where the conductor patch 25A is provided for the waveguide.

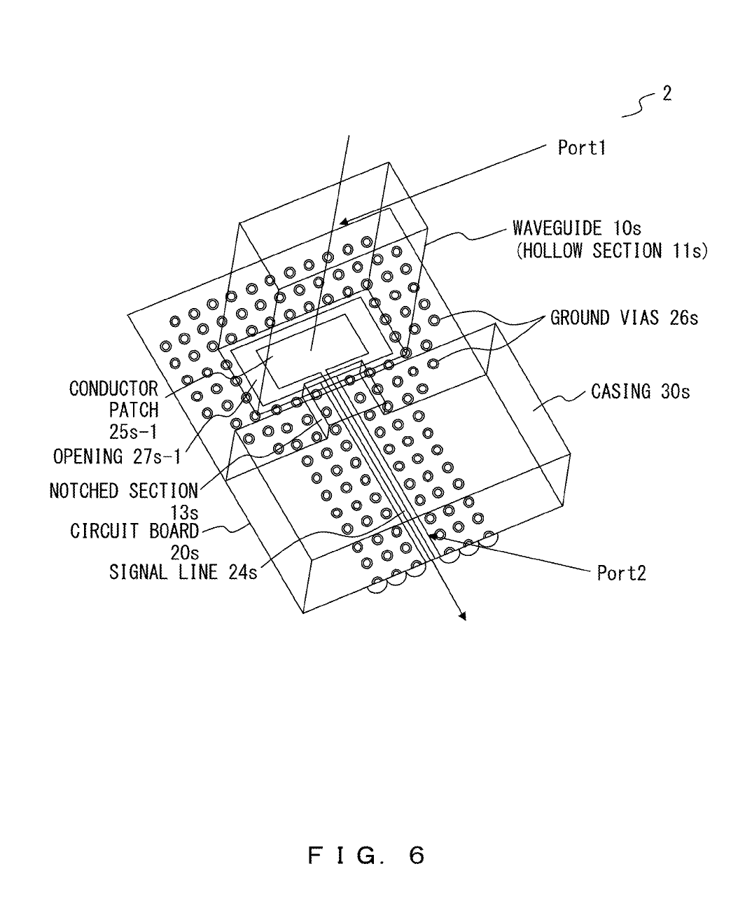

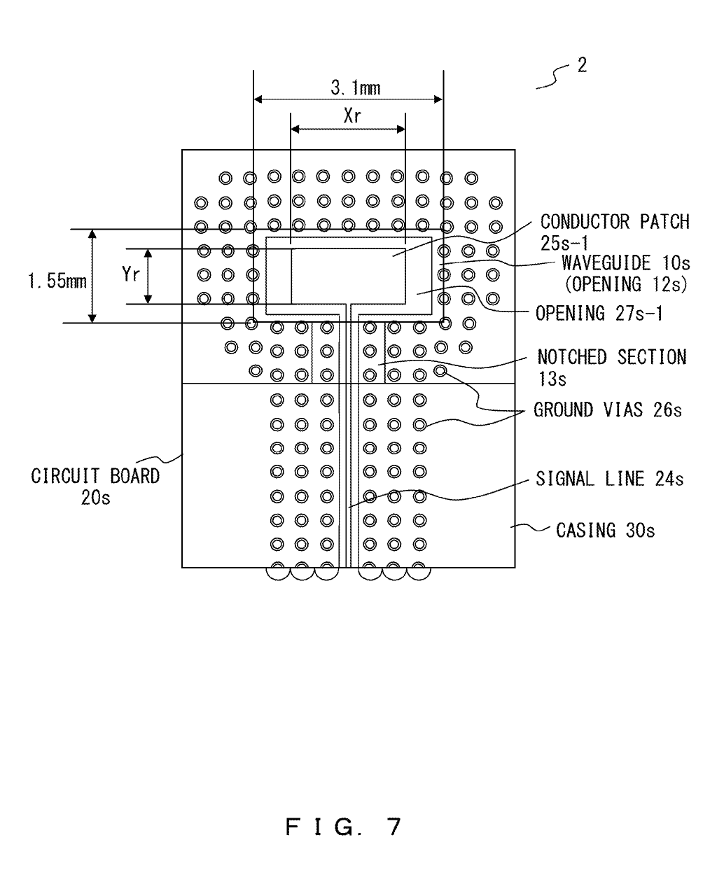

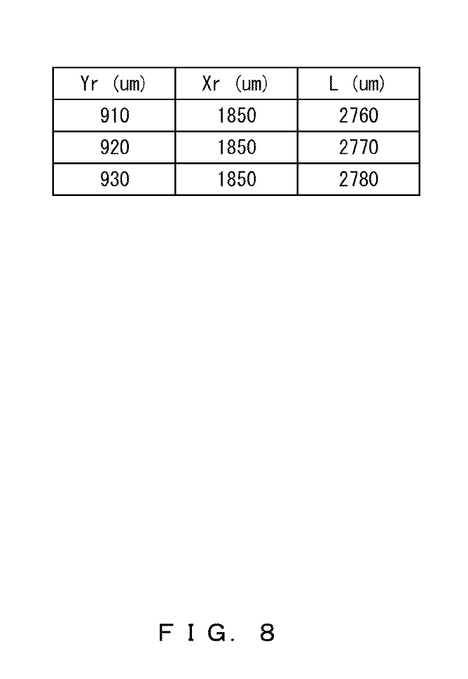

FIG. 6 is a perspective view of a simulation model of a waveguide converter that is provided with a rectangular patch. FIG. 7 is a top view of a simulation model of a waveguide converter that is provided with a rectangular patch. FIG. 8 is a list of the sizes of a rectangular patch for which a simulation analysis is performed.

A simulation model 2 of the waveguide converter illustrated in FIG. 6 and FIG. 7 is a simulation model of the waveguide converter that is provided with the rectangular conductor patch 25r instead of the conductor patch 25A.

A waveguide 10s illustrated in FIG. 6 and FIG. 7 corresponds to the waveguide 10. In the simulation model 2 of the waveguide converter illustrated in FIG. 6 and FIG. 7, a hollow section 11s that corresponds to the hollow section 11 and an opening 12s that corresponds to the opening 12 are set as a model of the waveguide 10s.

A circuit board 20s corresponds to the circuit board 20. A signal line 24s corresponds to the signal line 24. Ground vias 26s correspond to the ground vias 26.

A conductor patch 25s-1 corresponds to the rectangular patch 25r as illustrated in FIG. 4. The conductor patch 25s-1 is arranged within the opening 27s-1 of the circuit board 20s.

The conductor patch 25s-1 has a rectangular shape, where the short sides are parallel with the transmission direction of a signal from the signal line 24s, and the long sides are orthogonal to the transmission direction of the signal. In other words, as illustrated in FIG. 7, the conductor patch 25s-1 has the short sides in the same direction as the short sides of the opening 12s, and has the long sides in the same direction as the long sides of the opening 12s.

In FIG. 6 and FIG. 7, a casing 30s is illustrated that covers the signal line 24s that extends outside the waveguide 10s from the notched section 13s that corresponds to the notched section 13, and that is disposed on the circuit board 20s. The casing 30s is an element that is expediently provided for the simulation model 2 of the waveguide converter in order to analyze the behavior of an electromagnetic field by using an electromagnetic field simulation.

As illustrated in FIG. 6, a port 1 to which a signal is incident and reflected is on the waveguide 10s side, and a port 2 to which a signal is incident and reflected is on the signal line 24s side.

As set values for an electromagnetic field simulation, it is assumed that the relative permittivity ∈r and the thickness of a dielectric substrate included in the circuit board 20s are 4.1 and 60 (μm), respectively. Moreover, it is assumed that a dielectric loss tangent tan δ is 0.015. It is assumed that the conductivity and the thickness of the first and second conductor plates included in the circuit board 20s are 5.8e7 (s/m) and 37 (μm), respectively. It is assumed that the pitch of the ground vias 26s is 400 (μm). It is assumed that the line width of the signal line 24s is 100 (μm), and that the insulation space between the signal line 24s and the first conductor plate is 100 (μm).

Moreover, the length of the long sides of the opening 12s of the waveguide 10s is set to 3.1 (mm), and the length of the short sides is set to 1.55 (mm).

In regard to the size of the casing 30s, it is assumed that the upward height from the circuit board 20s is 2 (mm), the length in the direction the signal line 24s extends is 5.4 (mm), and that the width in the direction orthogonal to the direction the signal line 24s extends is 3.078 (mm).

As illustrated in FIG. 7, it is assumed that the length of the long sides of the rectangular conductor patch 25s-1 is Xᵣ, and that the length of the short sides is Yᵣ. Moreover, it is assumed that the total sum of the length of the long side Xᵣ and short sides Yᵣ (i.e., Xᵣ+Yᵣ) is length L.

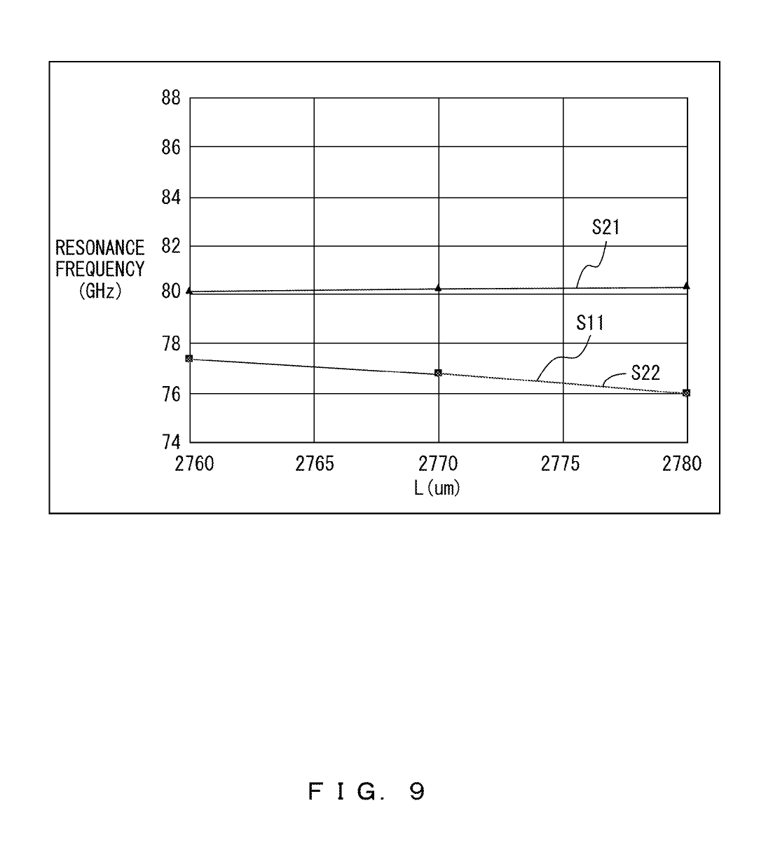

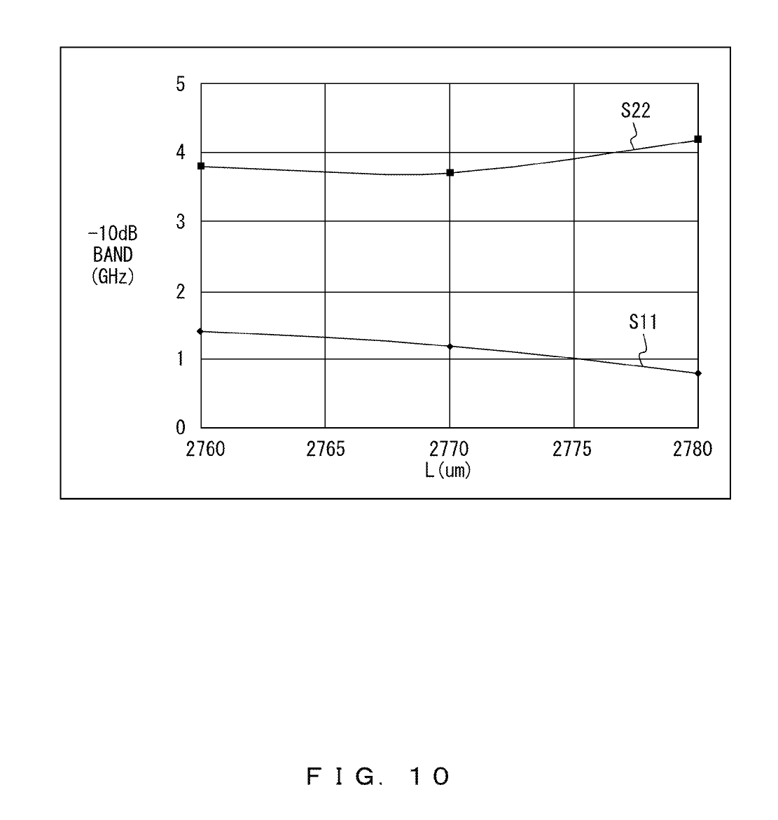

In an example of the electromagnetic field simulation below, as illustrated in FIG. 8, a simulation analysis is performed upon fixing the length of the long sides Xᵣ to 1850 (μm), and by varying the value of the length of the short sides Yᵣ and length L as depicted in FIG. 7. An example of the simulation result is depicted in FIG. 9 and FIG. 10.

FIG. 9 depicts the relationship between the length L of the rectangular patch and a resonance frequency of the pass characteristic or a resonance frequency of the reflection characteristic. FIG. 10 depicts the relationship between the length L of the rectangular patch and the band of reflection characteristic where the loss becomes −10 (dB).

Firstly, referring to FIG. 9, when the length Xᵣ of the long sides of the rectangular conductor patch 25s-1 is fixed to 1850 (μm) and the length of the short sides Yᵣ is varied, the resonance frequency that degrades the pass characteristic indicated by the scattering parameter S21 is nearly constant regardless of the value of the length L. On the other hand, the resonance frequency of the reflection characteristic indicated by the scattering parameters S11 and S22 changes to a low frequency due to the increase in the value of the length L, i.e., due to the increase in the value of the length of the short sides Yᵣ. As a result, it is understood that when the value of the length of the long sides Xᵣ of the rectangular conductor patch 25s-1 is fixed and the value of the length of the short sides Yᵣ increases, the distance increases between the resonance frequency of the reflection characteristic, i.e., the center frequency of an active frequency band, and the resonance frequency of a pass characteristic. Moreover, it is understood that the smaller the difference between the length of the short sides Yᵣ and the length of the long sides Xᵣ becomes, the larger the difference between the center frequency of an active frequency band and the resonance frequency of a pass characteristic becomes.

Next, referring to FIG. 10, when the length Xᵣ of the long sides of the rectangular conductor patch 25s-1 is fixed to 1850 (μm) and the length of the short sides Yᵣ is varied, the band where the loss of the reflection characteristic indicated by S11 becomes −10 (dB) decreases as the value of the length L increases, i.e., as the value of the length of the short sides Yᵣ increases. On the other hand, the band where the loss of the reflection characteristic indicated by S22 becomes −10 (dB) decreases and later increases as the value of the length L increases, i.e., as the value of the length of the short sides Yᵣ increases.

For example, it is assumed that a desirable value of the center frequency of an active frequency band, i.e., a desirable value of the resonance frequencies of the reflection characteristic S11 and S22, is 76.8 (GHz). In the simulation result depicted in FIG. 9 and FIG. 10, the length L at which the resonance frequencies of the reflection characteristic S11 and S22 become 76.8 (GHz) is 2770 (μm).

As illustrated in FIG. 8, the length of the short sides Yᵣ of the rectangular conductor patch 25r when the length L is 2770 (μm) is 920 (μm). Moreover, when the straight line L₁ that determines the undesired resonance frequency and the straight line L₂ that determines the center frequency of an active frequency band as described above with reference to FIG. 4 are calculated, the straight line L₁ and straight line L₂ have the same length, which is 1305 (μm).

Note that in the simulation example described above with reference to FIGS. 8 to 10, the length of the long sides of the conductor patch 25r is fixed and the length of the short sides is varied. However, an optimal length of the long sides at which the center frequency of an active frequency band, i.e., the resonance frequency of reflection characteristic, has a desirable value (for example, 76.8 (GHz)) may be obtained by fixing the length of the short sides of the conductor patch 25r and changing the length of the long sides.

Next, the shape and size of the conductor patch 25A of the waveguide converter 1 by which a desired signal conversion performance may be obtained will be described.

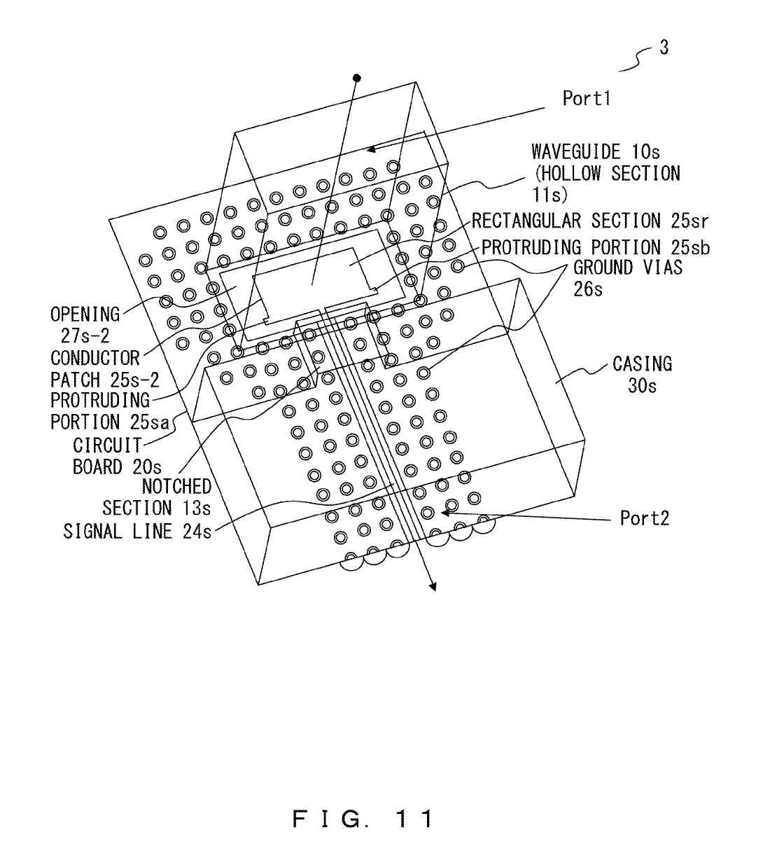

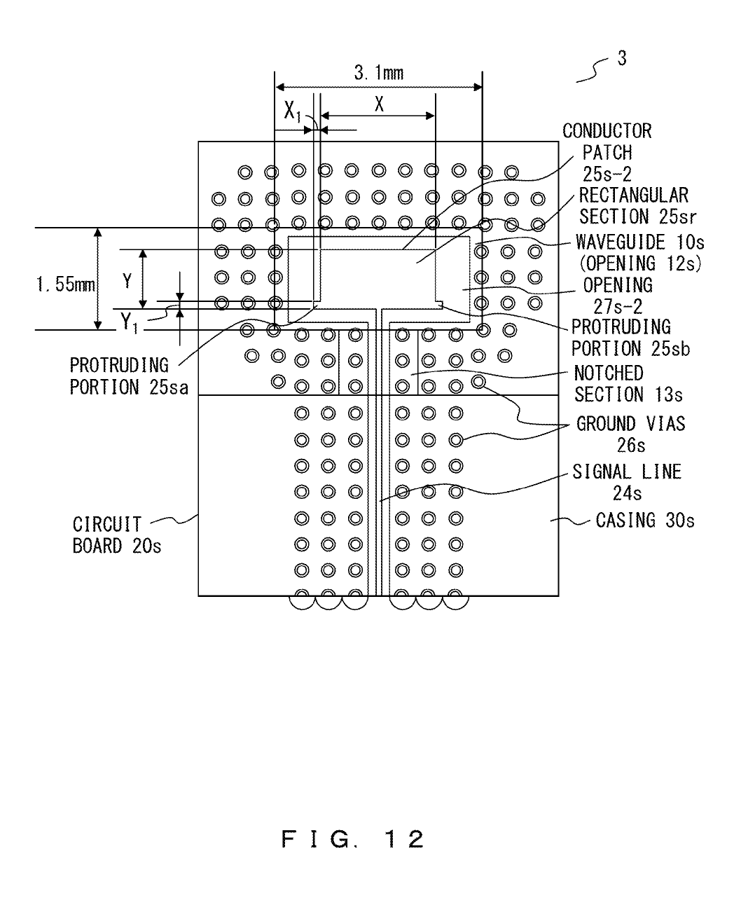

FIG. 11 is a perspective view of a simulation model of a waveguide converter that is provided with the conductor patch according to the first embodiment. FIG. 12 is a top view of a simulation model of a waveguide converter that is provided with the conductor patch according to the first embodiment.

The same reference signs as those assigned to elements of the simulation model 2 of the waveguide converter illustrated in FIG. 6 and FIG. 7 are assigned to the corresponding elements of the simulation model 3 of the waveguide converter illustrated in FIG. 11 and FIG. 12.

A waveguide 10s illustrated in FIG. 11 and FIG. 12 corresponds to the waveguide 10. In the simulation model 3 of the waveguide converter illustrated in FIG. 11 and FIG. 12, a hollow section 11s and an opening 12s are set as a model of the waveguide 10s.

A circuit board 20s corresponds to the circuit board 20. A signal line 24s corresponds to the signal line 24. Ground vias 26s correspond to the ground vias 26.

A conductor patch 25s-2 corresponds to the conductor patch 25A according to the first embodiment, as illustrated in FIG. 5.

As illustrated in FIG. 12, the conductor patch 25s-2 includes a rectangular section 25sr and protruding portions 25sa and 25sb. The rectangular section 25sr corresponds to the rectangular section 25Ar, and is a rectangular-shaped portion of the conductor patch 25s-2. The protruding portions 25sa and 25sb correspond to the protruding portions 25Aa and 25Ab, respectively, and are protruding portions of the conductor patch 25s-2.

The rectangular section 25sr has short sides in the direction parallel with the transmission direction of a signal on the signal line 24s, and has long sides in the direction orthogonal to the transmission direction of that signal. In other words, the rectangular section 25sr has short sides in the same direction as that of the short sides of the opening 12s, and has long sides in the same direction as that of the long sides of the opening 12s.

Moreover, the protruding portions 25sa and 25sb are provided on the short sides of the rectangular section 25sr near both ends of the long side of the rectangular section 25Ar, which is connected to the signal line 24s. In the simulation model 3 of the waveguide converter illustrated in FIG. 11 and FIG. 12, it is assumed that the protruding portions 25sa and 25sb are rectangular-shaped in a similar manner to the protruding portions 25Aa and 25Ab. As described above, the shape of the protruding portions 25Aa and 25Ab according to the first embodiment may be polygonal or circular instead of being rectangular.

In a similar manner to the simulation model 2 of the waveguide converter illustrated in FIG. 6 and FIG. 7, the simulation model 3 of the waveguide converter illustrated in FIG. 11 and FIG. 12 is provided with the casing 30s that covers the signal line 24s that extends outside the waveguide 10s from the notched section 13s, and that is disposed on the circuit board 20s. The casing 30s is an element that is expediently provided for the simulation model 3 of the waveguide converter in order to analyze the behavior of an electromagnetic field by using an electromagnetic field simulation. For this reason, as illustrated in FIG. 2 and FIG. 3, the casing 30s does not exist in the waveguide converter 1 according to the embodiment.

As illustrated in FIG. 11, a port 1 to which a signal is incident and reflected is on the waveguide 10s side, and a port 2 to which a signal is incident and reflected is on the signal line 24s side.

Except the size of the conductor patch 25s-2, set values are assigned to the simulation model 3 of the waveguide converter in a similar manner to the aforementioned simulation model 2 of the waveguide converter.

As illustrated in FIG. 12, the conductor patch 25s-2 is arranged within the opening 27s-2 of the circuit board 20s.

As illustrated in FIG. 12, it is assumed that the length of the long sides of the rectangular section 25sr is X, and that the length of the short sides is Y. In regard to the length of the sides of the protruding portions 25sa and 25sb, it is assumed that the length of the sides parallel with the long sides of the rectangular section 25sr is X₁, and that the length of the sides parallel with the short sides of the rectangular section 25sr is Y. Further, it is assumed that the length of the side of the conductor patch 25s-2 that is connected to the signal line 24s is X′. In other words, the length X′ is the sum of the length X of the long sides of the rectangular section 25sr and the length X₁ of the sides of the respective protruding portions 25sa and 25sb (i.e., X+2X₁).

An example of the analysis result of simulation performed by varying the size of the conductor patch 25s-2 according to the first embodiment will be described.

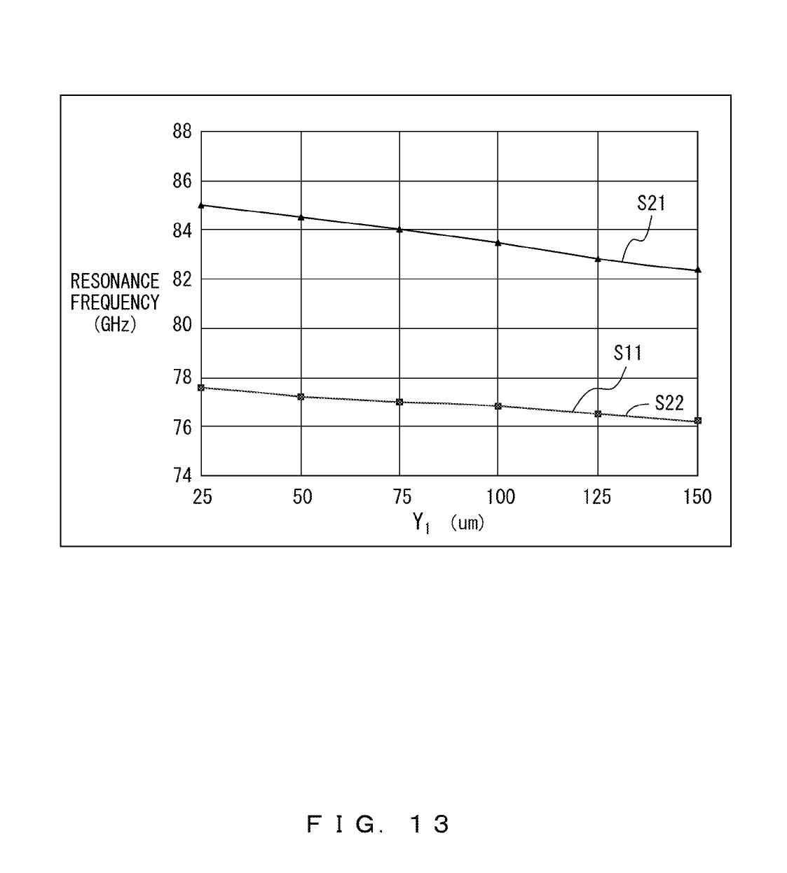

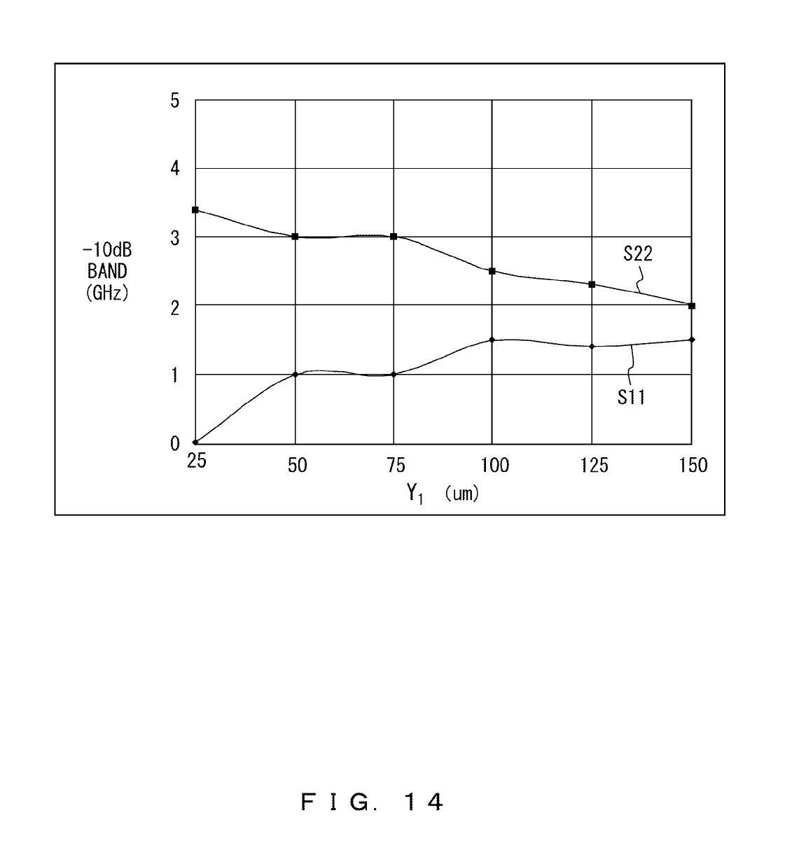

FIG. 13 depicts the relationship between Y₁ and a resonance frequency of the pass characteristic or a resonance frequency of the reflection characteristic when Y, X, and X₁ of the conductor patch according to the first embodiment are fixed and Y₁ is varied. FIG. 14 depicts the relationship between Y₁ and the band of reflection characteristic where the loss becomes −10 (dB) when Y, X, and X₁ of the conductor patch according to the first embodiment are fixed and Y₁ is varied.

In FIG. 13 and FIG. 14, a simulation result is depicted in cases where the values of Y, X, and X₁ are fixed to 895(μm), 1725 (μm), and 100 (μm), respectively, and the value of Y₁ is varied from 25 (μm) to 150 (μm).

Referring to FIG. 13, when Y, X, and X₁ of the conductor patch 25s-2 according to the first embodiment are fixed and Y₁ is varied, a resonance frequency that degrades the pass characteristic indicated by the scattering parameter S21 decreases as the value of Y₁ increases. Moreover, a resonance frequency of the reflection characteristic indicated by the scattering parameters S11 and S22 decreases as the value of Y₁ increases. In view of the above, it is understood that when Y, X, and X₁ of the conductor patch 25s-2 according to the first embodiment are fixed and Y₁ is varied, it is difficult to keep a resonance frequency that degrades the pass characteristic away from a resonance frequency of the reflection characteristic, i.e., the center frequency of an active frequency band, even if the value of Y₁ is increased.

Referring to FIG. 14, when Y, X, and X₁ of the conductor patch 25s-2 according to the first embodiment are fixed and Y₁ is varied, the band where the loss of the reflection characteristic indicated by the scattering parameter S11 becomes −10 (dB) increases as the value of Y₁ increases. On the other hand, the band where the loss of the reflection characteristic indicated by scattering parameter S22 becomes −10 (dB) decreases as the value of Y₁ increases. In view of the above, it is understood that when Y, X, and X₁ of the conductor patch 25s-2 according to the first embodiment are fixed and Y₁ is varied, it is not possible to increase the band where the loss becomes −10 (dB), i.e., an active frequency band that is suitable for actual use, by increasing the value of Y.

According to such a simulation result in FIG. 13 and FIG. 14, it is understood that even if Y, X, and X₁ of the conductor patch 25s-2 according to the first embodiment are fixed and Y₁ is varied, it is not possible to achieve the shape and size of the conductor patch 25s-2 in which the signal conversion performance of the waveguide converter 1 becomes optimal.

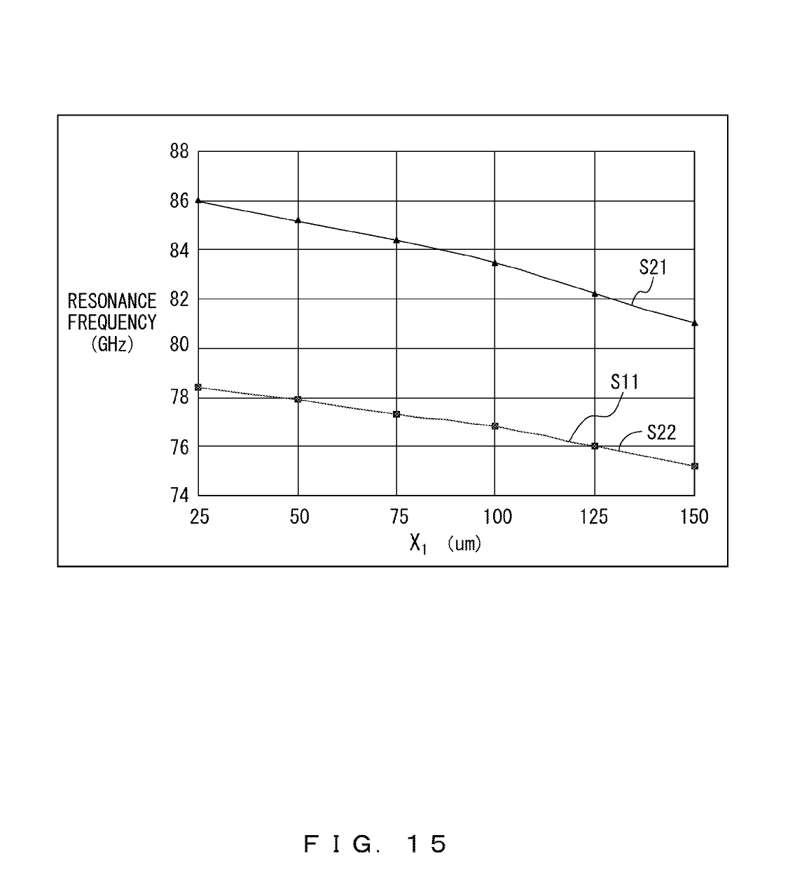

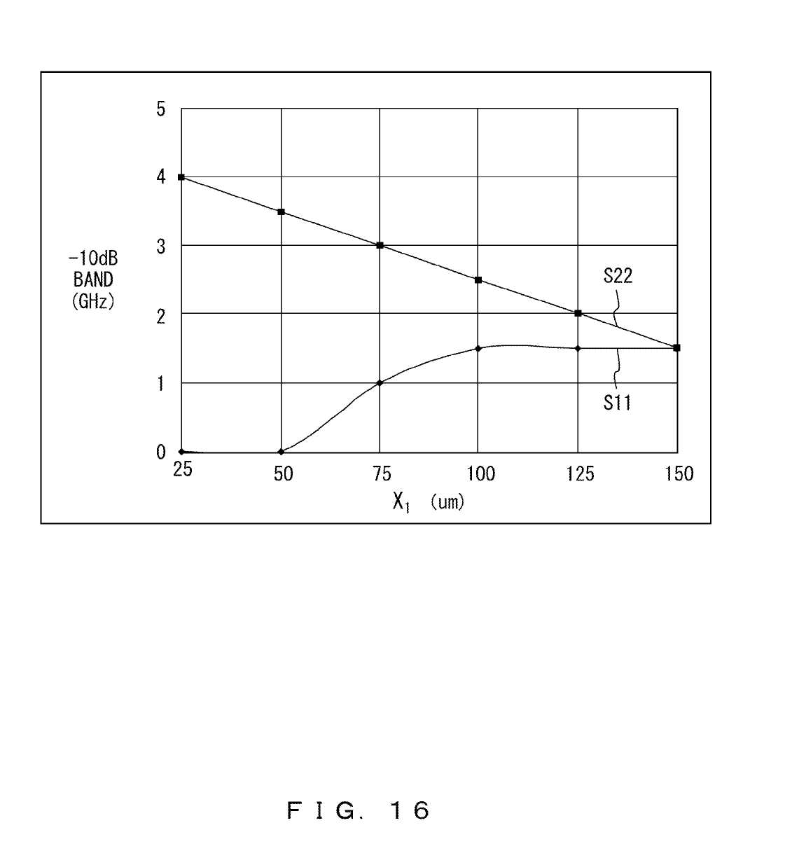

FIG. 15 depicts the relationship between X₁ and a resonance frequency of the pass characteristic or a resonance frequency of the reflection characteristic when Y, X, and Y₁ of the conductor patch according to the first embodiment are fixed and X₁ is varied. FIG. 16 depicts the relationship between X₁ and the band of reflection characteristic where the loss becomes −10 (dB) when Y, X, and Y₁ of the conductor patch according to the first embodiment are fixed and X₁ is varied.

In FIG. 15 and FIG. 16, a simulation result is depicted in cases where the values of Y, X, and Y₁ are fixed to 895 (μm), 1725 (μm), and 100 (μm), respectively, and the value of X₁ is varied from 25 (μm) to 150 (μm).

Referring to FIG. 15, when Y, X, and Y₁ of the conductor patch 25s-2 according to the first embodiment are fixed and X₁ is varied, a resonance frequency that degrades the pass characteristic indicated by the scattering parameter S21 decreases as the value of X₁ increases. Moreover, a resonance frequency of the reflection characteristic indicated by the scattering parameters S11 and S22 decreases as the value of X₁ increases. In view of the above, it is understood that when Y, X, and Y₁ of the conductor patch 25s-2 according to the first embodiment are fixed and X₁ is varied, it is difficult to keep a resonance frequency that degrades the pass characteristic away from a resonance frequency of the reflection characteristic, i.e., the center frequency of an active frequency band, even if the value of X₁ is increased.

Referring to FIG. 16, when Y, X, and Y₁ of the conductor patch 25s-2 according to the first embodiment are fixed and X₁ is varied, the band where the loss of the reflection characteristic indicated by the scattering parameter S11 becomes −10 (dB) increases when the value of X₁ is between 50 (μm) and 100 (μm) and remains constant afterward. On the other hand, the band where the loss of the reflection characteristic indicated by scattering parameter S22 becomes −10 (dB) decreases as the value of X₁ increases. In view of the above, it is understood that when Y, X, and Y₁ of the conductor patch 25s-2 according to the first embodiment are fixed and X₁ is varied, it is not possible to increase the band where the loss becomes −10 (dB), i.e., an active frequency band that is suitable for actual use, by increasing the value of X.

According to a simulation result such as that of FIG. 15 and FIG. 16, it is understood that even if Y, X, and Y₁ of the conductor patch 25s-2 according to the first embodiment are fixed and X₁ is varied, it is not possible to achieve the shape and size of the conductor patch 25s-2 in which the signal conversion performance of the waveguide converter 1 becomes optimal.

Furthermore, according to simulation results such as those in FIG. 15 and FIG. 16 as well as FIG. 13 and FIG. 14, the following is understood. When the length of the long sides and short sides of the rectangular section 25sr is fixed and only the length of either one of the long sides or short sides of the protruding portions 25sa and 25sb is varied, the relationship between the varied length of sides and a resonance frequency of the pass characteristic or a resonance frequency of the reflection characteristic indicates a similar tendency regardless of whether the length of any sides are varied. Moreover, it is understood that the relationship between the varied length of the sides and the band of reflection characteristic where the loss becomes −10 (dB) also indicates a similar tendency regardless of whether the length of any sides are varied.

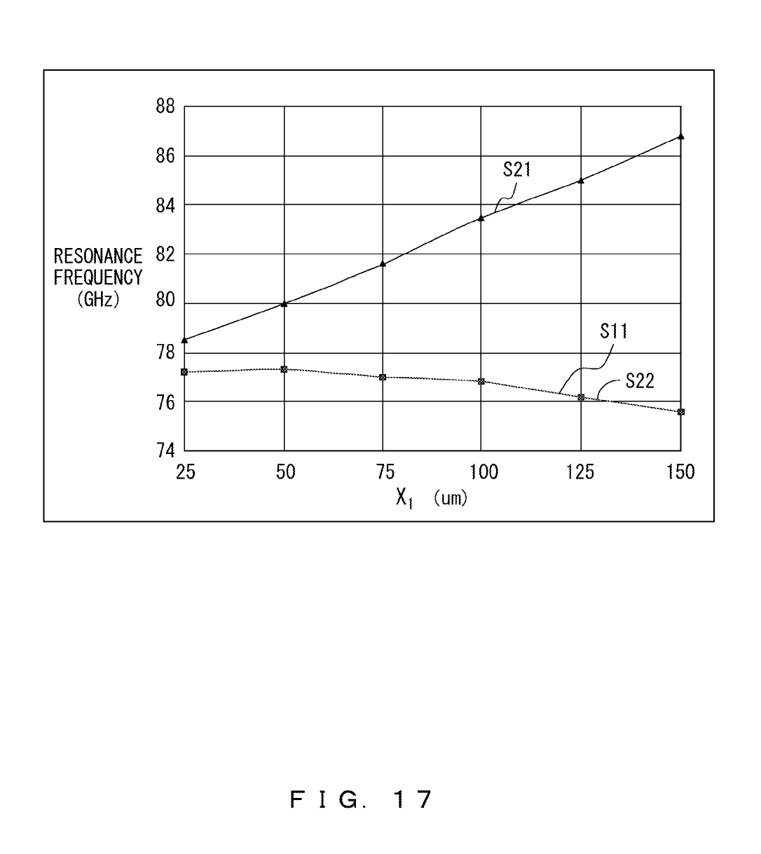

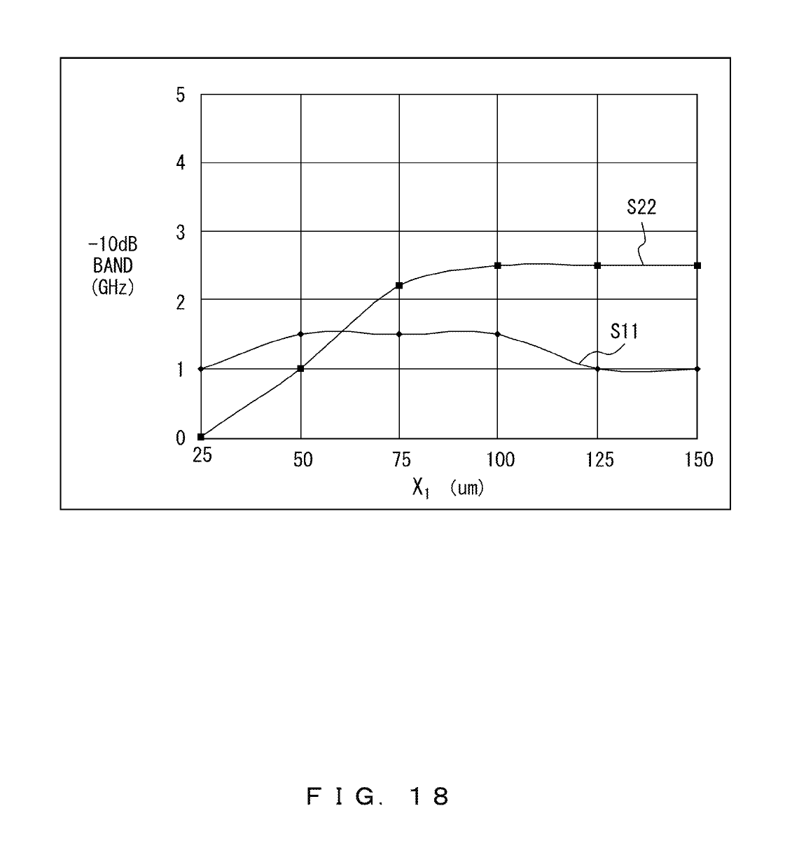

FIG. 17 depicts the relationship between X₁ and a resonance frequency of the pass characteristic or a resonance frequency of the reflection characteristic when Y, Y₁, and X′ of the conductor patch according to the first embodiment are fixed and X and X₁ are varied. FIG. 18 depicts the relationship between X₁ and the band of reflection characteristic where the loss becomes −10 (dB) when Y, Y₁, and X′ of the conductor patch according to the first embodiment are fixed and X and X₁ are varied.

In FIG. 17 and FIG. 18, a simulation result is depicted in cases where the values of Y, Y₁, and X′ are fixed to 895(μm), 100 (μm), and 1925 (μm), respectively, and the value of X₁ is varied from 25 (μm) to 150 (μm). If the length X′ of the side of the conductor patch 25s-2 that connects to the signal line 24s is fixed and the length X₁ of each side of the protruding portions 25sa and 25sb is varied, as a matter of course, the value of the length X of the long sides of the rectangular section 25sr is also varied.

Referring to FIG. 17, when Y, Y₁, and X′ of the conductor patch 25s-2 according to the first embodiment are fixed and X and X₁ are varied, a resonance frequency that degrades the pass characteristic indicated by the scattering parameter S21 increases as the value of X₁ increases. On the other hand, a resonance frequency of the reflection characteristic indicated by the scattering parameters S11 and S22 decreases as the value of X₁ increases. In view of the above, it is understood that when Y, Y₁, and X′ of the conductor patch 25s-2 according to the first embodiment are fixed and X and X₁ are varied, it is possible to keep a resonance frequency that degrades the pass characteristic away from a resonance frequency of the reflection characteristic, i.e., the center frequency of an active frequency band, if the value of X₁ is increased and the value of X is decreased.

Referring to FIG. 18, when Y, Y₁, and X′ of the conductor patch 25s-2 according to the first embodiment are fixed and X and X₁ are varied, the band where the loss of the reflection characteristic indicated by S22 becomes −10 (dB) increases as the value of X₁ increases and remains almost constant when the value of X₁ becomes equal to or larger than 100 (μm). On the other hand, the band where the loss of the reflection characteristic indicated by S11 becomes −10 (dB) increases as the value of X₁ increases, reaches the peak until the value of X₁ is within a certain range (50 (μm)-100 (μm)) and decreases afterward. In view of the above, it is understood that when Y, Y₁, and X′ of the conductor patch 25s-2 according to the first embodiment are fixed and X and X₁ are varied, the band where the loss becomes −10 (dB), i.e., a frequency band that is suitable for actual use, may be increased by increasing the value of X₁ into a certain range.

According to a simulation result such as that of FIG. 17 and FIG. 18, it is understood that when Y, Y₁, and X′ of the conductor patch 25s-2 according to the first embodiment are fixed and X and X₁ are varied, it is possible to achieve the shape and size of the conductor patch 25s-2 in which the signal conversion performance of the waveguide converter 1 becomes optimal by increasing the value of X₁ into a certain range.

Hence, in view of the verification result described with reference to FIGS. 13 to 16 and the verification result described with reference to FIGS. 17 to 18, a simulation is further performed by fixing X′ and increasing X₁, Y₁, X, and Y. Note that the verification result described with reference to FIGS. 13 to 16 is a verification result in which even if the value of the long sides and short sides of the rectangular section 25sr is fixed and only the value of either one of the long sides or the shot sides of the protruding portions 25sa and 25sb is varied, it is not possible to achieve the optimal shape and size of the conductor patch 25s-2. Also, note that the verification result described with reference to FIGS. 17 to 18 is a verification result in which if the value of the side of the conductor patch 25s-2 that connects to the signal line 24s is fixed and the value of the sides of the protruding portions 25sa and 25sb that are parallel with the aforementioned side is adjusted, it is possible to achieve the optimal shape and size of the conductor patch 25s-2.

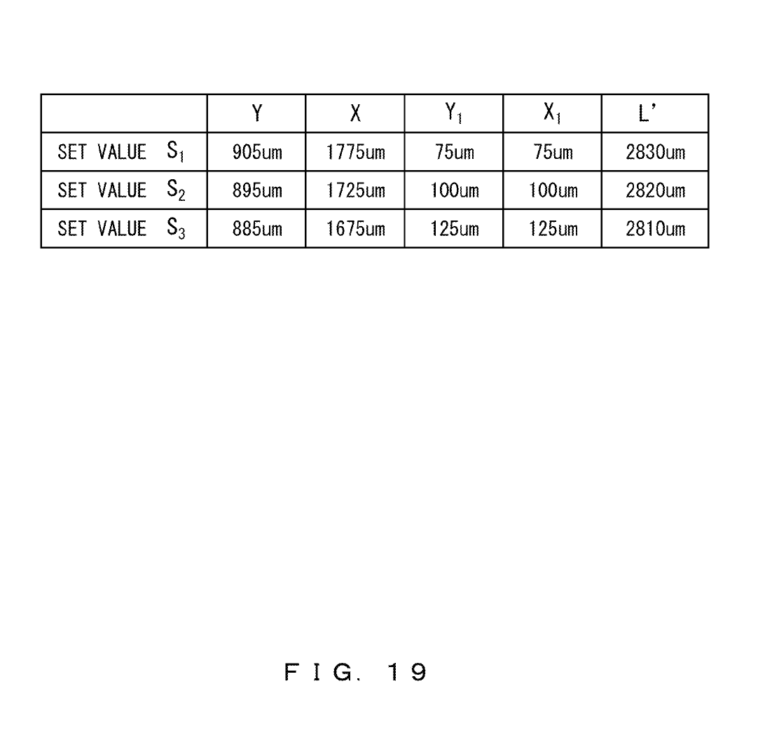

FIG. 19 is a list of the sizes of the conductor patch according to the first embodiment for which a simulation analysis is performed by fixing X′ and increasing X₁, Y₁, X, and Y.

For example, it is assumed that a desired value of the center frequency of an active frequency band, i.e., the resonance frequency of the reflection characteristic, is 76.8 (GHz). In an example of the simulation below, set values S₁-S₃ are assigned in such a manner that a resonance frequency of the reflection characteristic becomes 76.8 (GHz) as illustrated in FIG. 19. In other words, the value of X′(i.e., X+2X₁) is fixed to 1925 (μm), and the values of the lengths X₁ and Y₁ of both sides of the protruding portions 25sa and 25sb are the same. Then, X₁, Y₁, X, Y, and L′ are varied like the set values S₁-S₃ of the simulation. Note that the length L′ of FIG. 19 indicates the sum of Y and X′ (i.e., Y+X+2X₁).

In regard to set values S₁-S₃, the straight line L1′ that determines an undesired resonance frequency, which is described above with reference to FIG. 5, is longer than the straight line L2′ that determines the center frequency of an active frequency band. For example, in the set value S₂, the straight line L₁′ is 1250 (μm), and straight line L₂′ is 1243(μm).

As described above, in the simulation model 2 of the waveguide converter provided with the conductor patch 25s-1, the length of the short sides Yᵣ of the conductor patch 25s-1 where the center frequency of an active frequency band becomes 76.8 (GHz) when the length Xᵣ of the long sides is fixed to 1850(μm) is 920 (μm). If the size of the conductor patch 25s-1 is compared with the size of the conductor patch 25s-2 with the set values S₁-S₃, the length Y of the short sides of the rectangular section 25sr that constitutes the conductor patch 25s-2 is shorter than the length of the short sides Yᵣ of the conductor patch 25s-1 with any of the set values S₁-S₃. Moreover, the length X of the long sides of the rectangular section 25sr is also shorter than the length Xᵣ of the long sides of the conductor patch 25s-1 with any of the set values S₁-S₃.

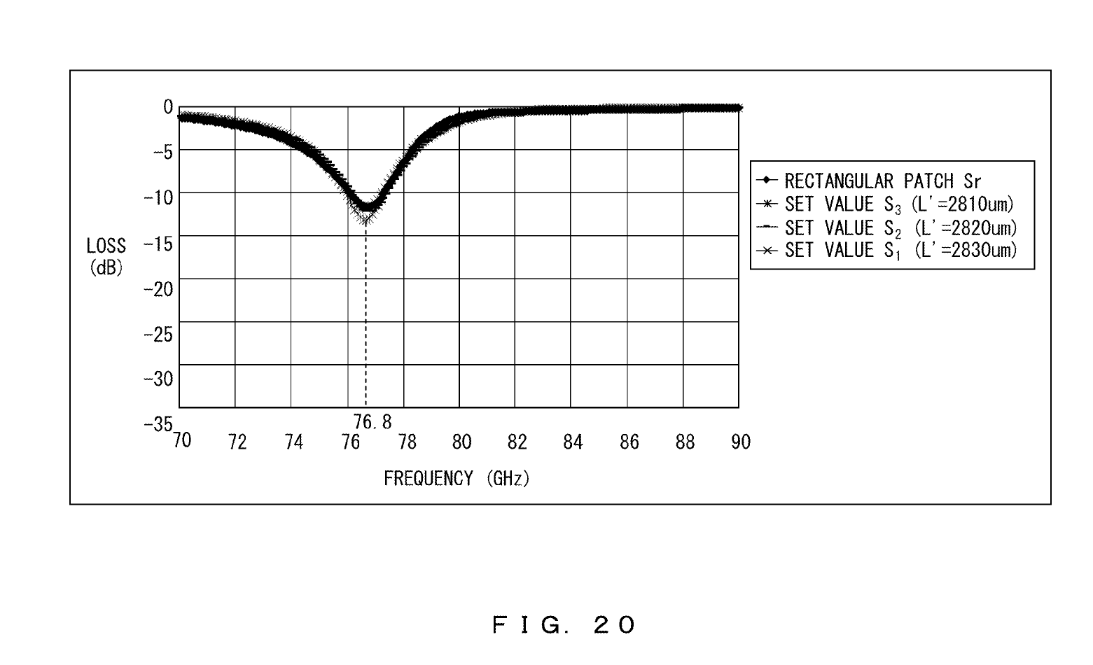

An example of the simulation result in which the shape and size of the conductor patch 25s-2 are varied as depicted in FIG. 19 is depicted in FIGS. 20 to 22.

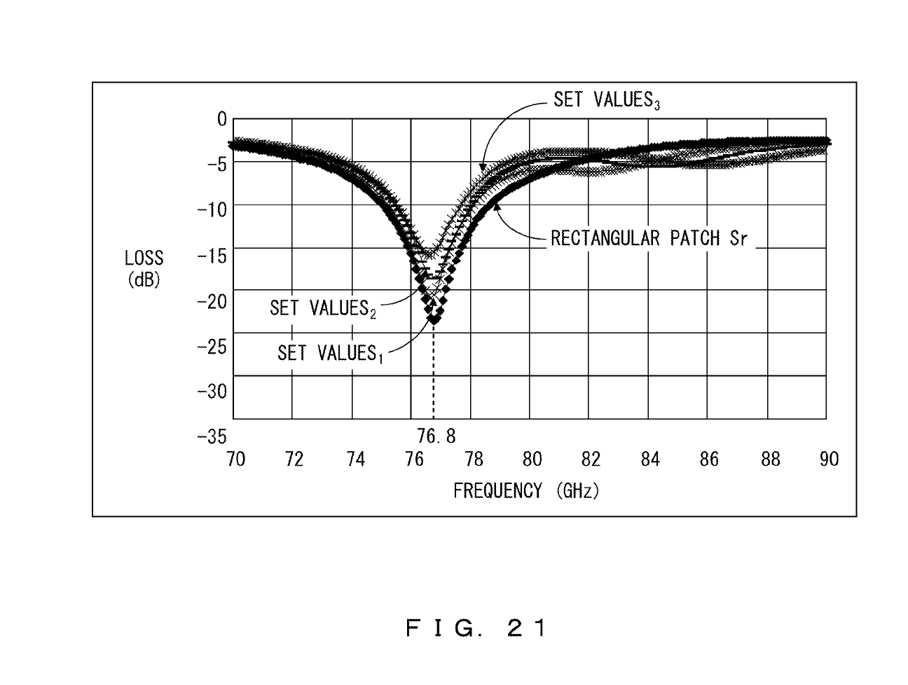

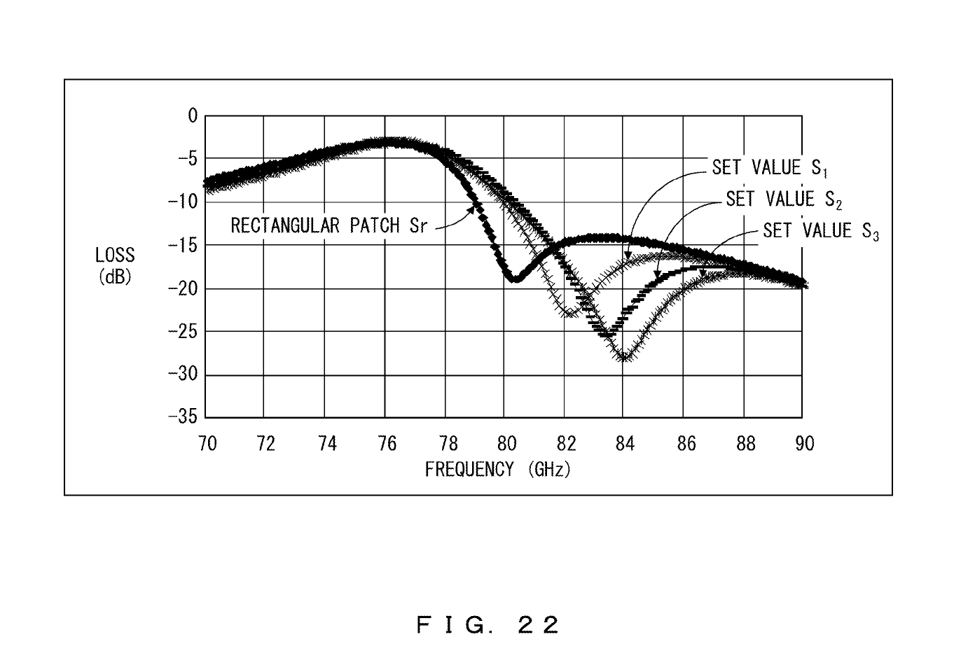

FIG. 20 depicts the reflection characteristic S11 in cases where X′ of the conductor patch according to the first embodiment is fixed and the values of X₁ and Y₁ are increased. FIG. 21 depicts the reflection characteristic S22 in cases where X′ of the conductor patch according to the first embodiment is fixed and the values of X₁ and Y₁ are increased. FIG. 22 depicts the pass characteristic S21 in cases where X′ of the conductor patch according to the first embodiment is fixed and the values of X₁ and Y₁ are increased.

In FIGS. 20 to 23, a simulation result Sᵣ of the rectangular-shaped conductor patch 25s-1 is also depicted in order to compare with a simulation result of the conductor patch 25s-2. The simulation result Sᵣ of the conductor patch 25s-1 is a simulation result of the case in which the conductor patch 25s-1 is set to a size where a resonance frequency of the reflection characteristic indicated by the scattering parameters S11 and S22 becomes 76.8 (GHz). In particular, as described above with reference to FIG. 9 and FIG. 10, the size of the conductor patch 25s-1 is determined in such a manner that the length Xᵣ of the long sides becomes 1850(μm), the length Yᵣ of the short sides becomes 920 (μm) and that the length L that is the sum of Xᵣ and Yᵣ becomes 2770 (μm).

Referring to FIG. 20, resonance frequencies of the reflection characteristic S11 with set values S₁-S₃ indicate 76.8 (GHz) in a similar manner to the simulation result Sᵣ of the conductor patch 25s-1. Referring to FIG. 21, resonance frequencies of the reflection characteristic S22 with set values S₁-S₃ also indicate 76.8 (GHz) in a similar manner to the simulation result Sᵣ of the conductor patch 25s-1.

Referring to FIG. 22, simulation results with set values S₁-S₃ have a wider band where the loss of the pass characteristic S21 becomes −8(dB) than the simulation result Sᵣ. Moreover, in regard to a resonance frequency of the pass characteristic S21, simulation results with set values S₁-S₃ are further distant from resonance frequencies of the reflection characteristic S11 and S22 (76.8 (GHz)) than the simulation result Sᵣ of the conductor patch 25s-1.

Accordingly, it is understood that an active frequency band that withstands actual use may become broader when the waveguide converter 1 provided with the conductor patch 25A according to the first embodiment is used than when the waveguide converter that includes the rectangular conductor patch 25r is used. Moreover, it is understood that a resonance frequency that degrades the pass characteristic may be further kept away from the center frequency of an active frequency band when the waveguide converter 1 provided with the conductor patch 25A according to the first embodiment is used than when the waveguide converter that includes the rectangular conductor patch 25r is used.

Further referring to FIG. 22, a frequency band where the loss of the pass characteristic S21 becomes −8 (dB) is the narrowest in the cases of set value S₁ and is the broadest in the case of set value S₃ among set values S₁-S₃.

A resonance frequency of the pass characteristic S21 is the closest to the resonance frequencies of the reflection characteristic S11 and S22 (76.8 (GHz)) in the case of set value S₁ and is the furthest from the resonance frequencies of the reflection characteristic S11 and S22 in the case of set value S₃ among set values S₁-S₃.

On the other hand, referring to FIG. 21, a frequency band of the reflection characteristic S22 where the loss becomes −10 (dB) is the narrowest in the cases of set value S₃ and is the broadest in the case of set value S₁ among set values S₁-S₃.

Thus, the size of the conductor patch 25s-2 in which the signal conversion performance becomes optimal among set values S₁-S₃ in view of not only the pass characteristic S21 but also the reflection characteristic S11 and S22 is determined as follows by further analyzing the reflection coefficients S11 and S22.

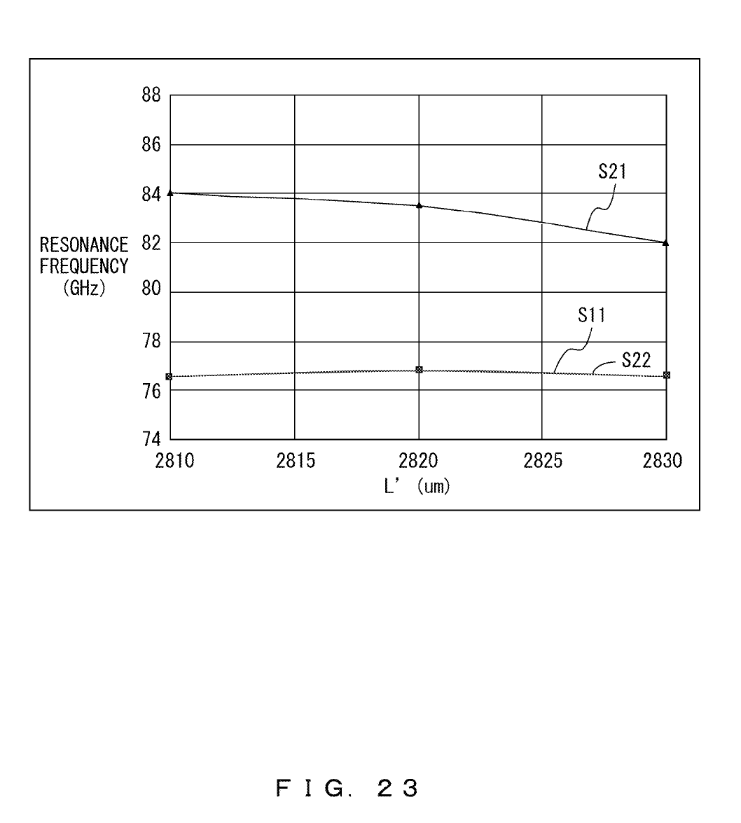

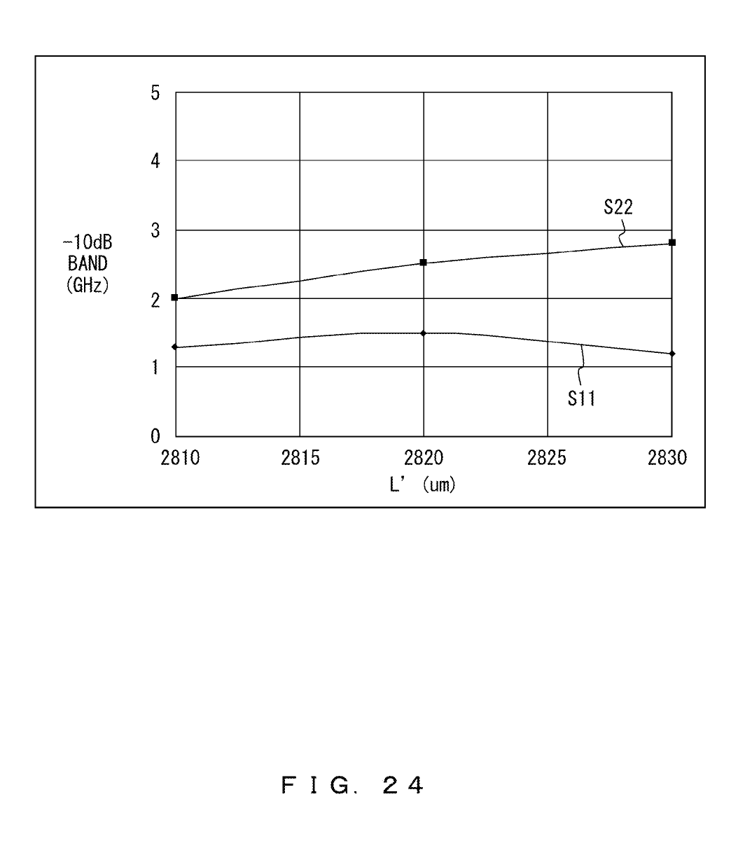

FIG. 23 depicts the relationship between L′ and a resonance frequency of the pass characteristic or a resonance frequency of the reflection characteristic when X′ is fixed and X₁, Y₁, X, and Y are increased. FIG. 24 depicts the relationship between L′ and the frequency band of reflection characteristic where the loss becomes −10 (dB) when X′ is fixed and X₁, Y₁, X, and Y are increased. As depicted in FIG. 19, the value of the length L′ of the set value S₁ is 2810 (μm) the value of the length L′ of the set value S₂ is 2820 (μm) and the value of the length L′ of the set value S₃ is 2830(μm).

Referring to FIG. 23, resonance frequencies of the reflection characteristic S11 and S22 are constant at 76.8 (GHz) regardless of the increase in the value of the length L′ (i.e., Y+X′). This is consistent with the fact that the resonance frequencies of the reflection characteristic S11 and S22 with set values S₁-S₃ are both at 76.8 (GHz) in FIG. 20 and FIG. 21.

Referring to FIG. 23, a resonance frequency that impairs the pass characteristic S21 decreases as the value of the length L′ increases. This is consistent with the fact that in FIG. 22, a resonance frequency of the pass characteristic S21 with the set value S₃ is the highest and a resonance frequency of the pass characteristic S21 with the set value S₁ is the lowest among the set values S₁-S₃.

Thus, the size of the conductor patch 25s-2 in which the signal conversion performance of the waveguide converter 1 becomes optimal in view of not only the pass characteristic S21 but also the reflection characteristic S11 and S22 will be further analyzed with reference to FIG. 24.

In FIG. 24, the frequency band where the loss of the reflection characteristic S22 becomes −10 (dB) increases as the value of the length L′ increases. This is consistent with the fact that the frequency band where the loss of the reflection characteristic S22 becomes −10 (dB) is the narrowest in the cases of set value S₃ and is the broadest in the case of set value S₁ among set values S₁-S₃ in FIG. 21.

On the other hand, in FIG. 24, as the value of the length L′ increases, the frequency band where the loss of the reflection characteristic S11 becomes −10 (dB) reaches a peak when the value of the length L′ is at 2820 (μm), and decreases afterward.

As a result of such simulation as depicted in FIG. 24, it is possible to determine that the optimal size of the conductor patch 25s-2 in which the reflection characteristic S22 and the reflection characteristic S11 are the best is the set value S₂ among the set values S₁-S₃ with which superior pass characteristic S21 may be obtained in comparison with the waveguide converter provided with the rectangular conductor patch 25s-1.

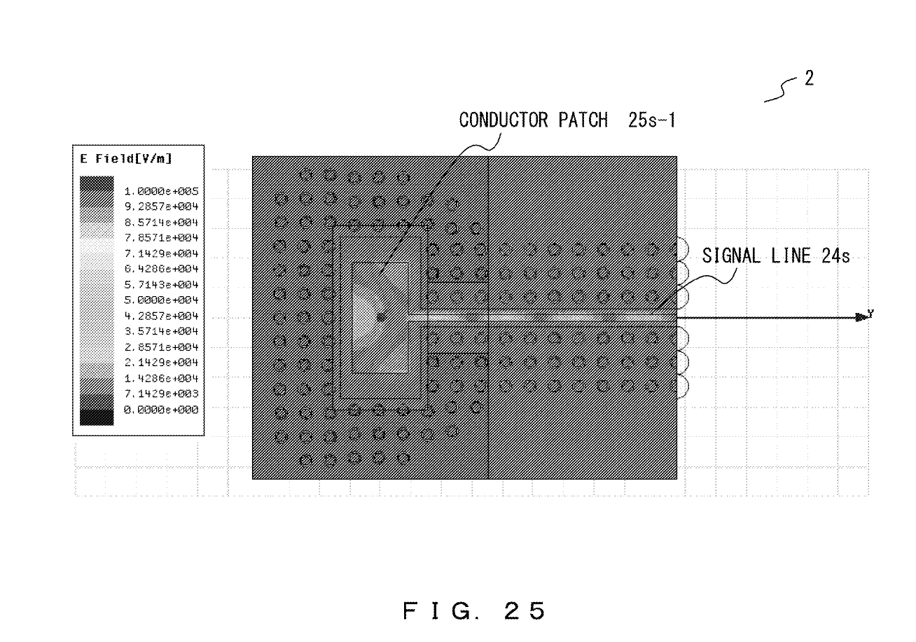

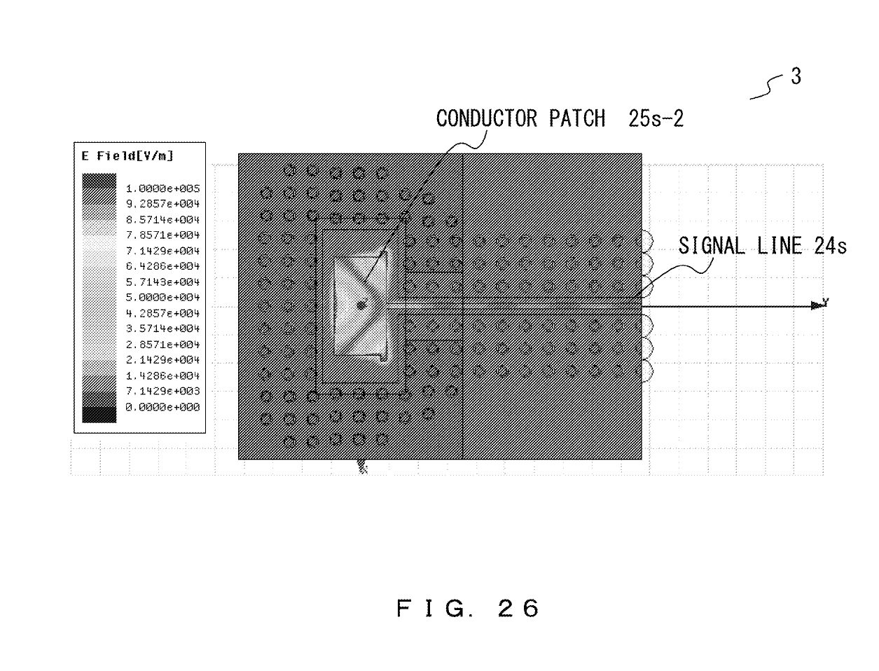

FIG. 25 depicts an electric field intensity distribution of the pass characteristic S21 in the resonance frequency of a rectangular conductor patch. FIG. 26 depicts an electric field intensity distribution of the pass characteristic S21 in the resonance frequency of a conductor patch according to the first embodiment.

The electric field intensity distribution of FIG. 25 is an electric field intensity distribution on the circuit board 20s in the resonance frequency 80.3 (GHz) of the pass characteristic S21 when the short side Y of the conductor patch 25s-1 is 920(μm) and the long side X is 1850(μm). As illustrated in FIG. 20 and FIG. 21, when the short side Y of the conductor patch 25s-1 is 920 (μm) and the long side X is 1850 (μm), resonance frequencies of the reflection characteristic S11 and S22 are 76.8 (GHz). As illustrated in FIG. 22, when the short side Y of the conductor patch 25s-1 is 920 (μm) and the long side X is 1850 (μm), a resonance frequency of the pass characteristic S21 is 80.3 (GHz).

On the other hand, an electric field intensity distribution illustrated in FIG. 26 is an electric field intensity distribution on the circuit board 20s in the resonance frequency 83.5 (GHz) of the pass characteristic S21 when the set value S₂ of FIG. 19 is applied to the size of the conductor patch 25s-2. As illustrated in FIG. 20 and FIG. 21, when the set value S₂ is applied to the size of the conductor patch 25s-2, a resonance frequencies of the reflection characteristic S11 and S22 are at 76.8 (GHz). As illustrated in FIG. 22, when the set value S₂ is applied to the size of the conductor patch 25s-2, a resonance frequency of the pass characteristic S21 is at 83.5 (GHz).

FIG. 25 and FIG. 26 are compared with each other as follows. In an electric field intensity distribution of FIG. 25, it is merely indicated that at regions near both ends of a long side of the conductor patch 25s-1 that is connected to the signal line 24s, and at a region near the center of the other long side of the conductor patch 25s-1, an electric field intensity does not become low. In other words, in a resonance frequency of the pass characteristic S21 of the waveguide converter provided with the conductor patch 25s-1, the electromagnetic field intensity on the circuit board 20s is extensively low.

On the other hand, in an electric field intensity distribution of FIG. 26, no electromagnetic field intensity becomes the minimum value except the electric field intensity at the region that extends from the center of a side of the conductor patch 25s-2 to which the signal line 24s is connected to both ends of the other side of the conductor patch 25s-2 which is parallel with the aforementioned side. In other words, in a resonance frequency of the pass characteristic S21 of the waveguide converter provided with the conductor patch 25s-2, the electromagnetic field intensity on the circuit board 20s is extensively high.

Accordingly, it is also understood from the electric field intensity distributions of FIG. 25 and FIG. 26 that the signal conversion performance of the waveguide converter 1 provided with the conductor patch 25A including the protruding portions 25Aa and 25Ab is superior to the signal conversion performance of the waveguide converter that includes the rectangular conductor patch 25r.

As described above, the waveguide converter 1 that is provided with the conductor patch 25A including the protruding portions 25Aa and 25Ab may broaden the active frequency band in comparison with the waveguide converter that includes the rectangular conductor patch 25r. In other words, it becomes possible to broaden a band in which the loss in the pass characteristic indicated by the scattering parameter S21 becomes a loss that is permissible in the actual use (for example, −8 (dB)).

Moreover, the waveguide converter 1 that is provided with the conductor patch 25A including the protruding portions 25Aa and 25Ab may keep a resonance frequency that degrades the pass characteristic away from the center frequency of an active frequency band in comparison with the waveguide converter that includes the rectangular conductor patch 25r.

Accordingly, the waveguide converter according to the present embodiment may broaden the active frequency band at the design stage, and may keep a resonance frequency that degrades the pass characteristic away from the center frequency of an active frequency. As a result, even if a resonance frequency that degrades the pass characteristic deviates, for example, due to the variation in dimension and alignment caused when the waveguide converter is manufactured, a deterioration in the pass characteristic may be minimized, and a required signal conversion performance may be secured. As it is possible to secure a required signal conversion performance without requiring a high accuracy in manufacturing, the required accuracy in manufacturing of a waveguide converter is not necessarily very high, and the cost reduction of a waveguide converter may be realized.

Further, according to the present embodiment, simulation analysis is performed, and thereby an appropriate shape and size of a conductor patch that has protruding portions on the short sides near both ends of the long side of a rectangular section on the signal line side may be determined in view of not only the pass characteristic S21 but also the reflection characteristic S11 and S22.

Note that as described above, the shape and size of the conductor patch according to the first embodiment is not limited to the shape and size illustrated in FIGS. 2, 3, and 5 to 26. For example, the shape of the protruding portions 25Aa and 25Ab is not necessarily rectangular, but may be polygonal or circular.

### Second Embodiment

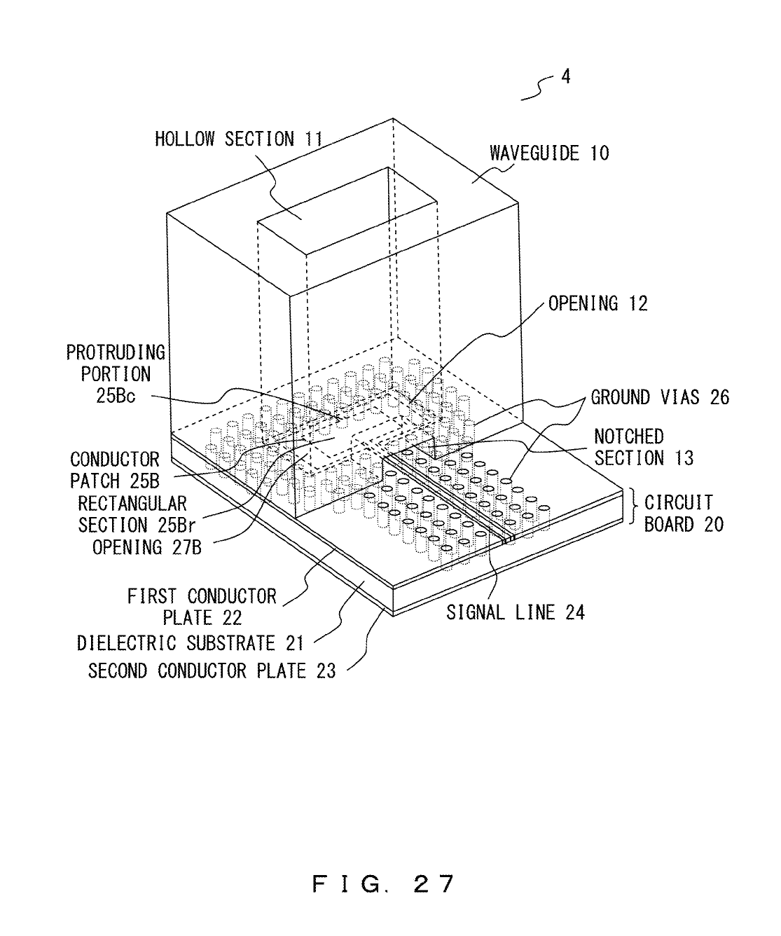

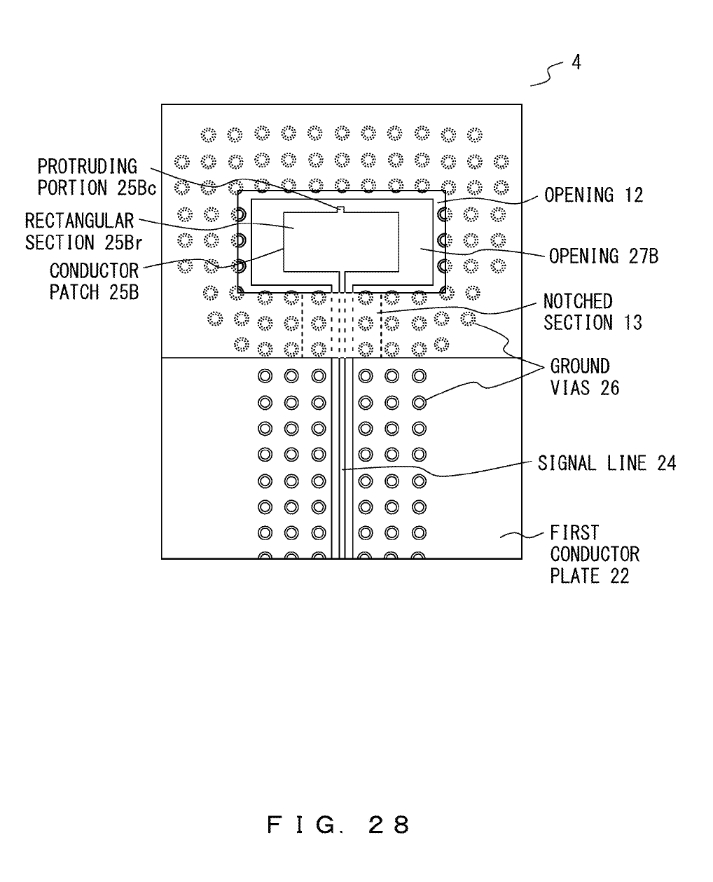

FIG. 27 is a perspective view of an example of the waveguide converter according to the second embodiment. FIG. 28 is a top view of an example of the waveguide converter according to the second embodiment.

Note that the same reference signs as those assigned to elements of the waveguide converter 1 according to the first embodiment illustrated in FIG. 2 and FIG. 3 are assigned to the corresponding elements of the waveguide converter 4 according to the second embodiment illustrated in FIG. 27 and FIG. 28.

The waveguide converter 4 of FIG. 27 and FIG. 28 has the conductor patch 25B within the opening 27B of the circuit board 20.

As illustrated in FIG. 27 and FIG. 28, the conductor patch 25B according to the second embodiment includes a rectangular section 25Br and a protruding portion 25Bc. The rectangular section 25Br is a rectangular-shaped portion of the conductor patch 25B. The protruding portion 25Bc is a protruding-shaped portion of the conductor patch 25B.

The rectangular section 25Br has short sides in the direction parallel with the transmission direction of a signal on the signal line 24, and has long sides in the direction orthogonal to the transmission direction of that signal. In other words, the rectangular section 25Br has short sides in the same direction as that of the short sides of the hollow section 11 of the waveguide 10, and has long sides in the same direction as that of the long sides of the hollow section 11.

As illustrated in FIG. 27 and FIG. 28, the protruding portion 25Bc is provided at the center of a long side of the rectangular section 25Br other than the long side of the rectangular section 25Br that is connected to the signal line 24.

The protruding portion 25Bc having a rectangular shape is depicted in FIG. 27 and FIG. 28, but the protruding portion 25Bc may be a square or rectangle. Moreover, the shape of the protruding portion 25Bc may be polygonal or circular.

When the protruding portion 25Bc is rectangular-shaped as illustrated in FIG. 27 and FIG. 28, sides of the protruding portion 25Bc that are parallel with the short sides of the rectangular section 25Br exist. Moreover, sides of the protruding portion 25Bc that are parallel with the long sides of the rectangular section 25Br exist.

The conductor patch 25B may be arranged in such a manner that a center line that vertically divides the long sides of the rectangular section 25Br into two equal parts matches a center line that vertically divides the long sides of the opening 12 of the waveguide 10 into two equal parts. Moreover, the conductor patch 25B may be arranged in such a manner that the signal line 24 is connected onto a center line that vertically divides the long sides of the rectangular section 25Br into two equal parts.

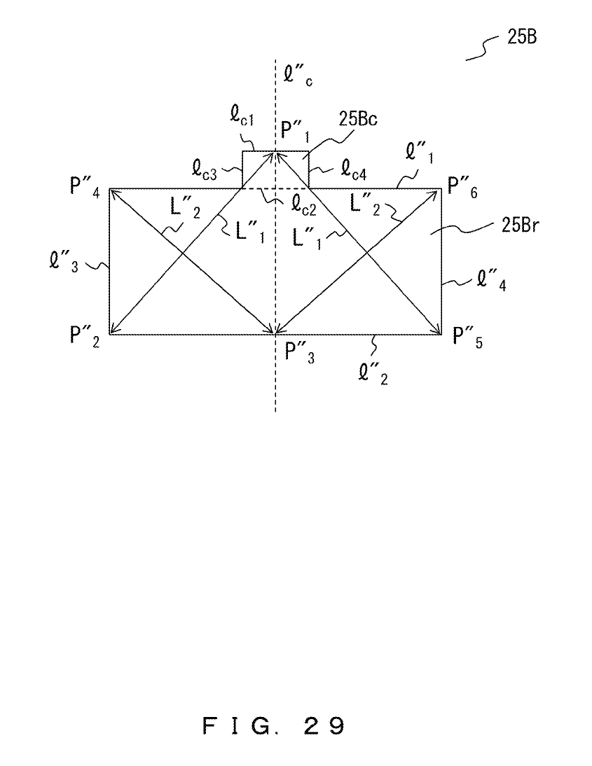

FIG. 29 is a drawing for explaining the relationship between the shape of a conductor patch according to the second embodiment and a frequency characteristic.

In FIG. 29, the signal line 24 is connected to a long side l₂″ side of the rectangular section 25Br at the bottom of FIG. 29, and the conductor patch 25B is arranged within the opening 12 of the waveguide 10.

The rectangular section 25Br is provided with long sides l₁″ and l₂″ and short sides l₃″ and l₄″. The long sides l₁″ and l₂″ are parallel with the long sides of the waveguide 10, and the short sides l₃″ and l₄″ are parallel with the short sides of the waveguide 10.

The protruding portion 25Bc is arranged at the center of a long side l₁″ of the rectangular section 25Br, which is an another long side in parallel with the long side l₂″ that is connected to the signal line 24.

The protruding portion 25Bc includes sides l_{c1}-l_{c4}. The side l_{c1} is parallel with the side l_{c2}, and the side l_{c3} is parallel with the side l_{c4}.

The sides l_{c3} and l_{c4} of the protruding portion 25Bc exist in parallel with the short sides l₃″ and l₄″ of the rectangular section 25Br. The side l_{c2} of the protruding portion 25Bc overlaps with the long side l₁″ of the rectangular section 25Br, and the side l_{c1} of the protruding portion 25Bc that is parallel with the side l_{c2} is parallel with the long side l₁″.

Firstly, an undesired resonance frequency in the waveguide converter 4 that includes the conductor patch 25B of FIG. 29, i.e., a resonance frequency that degrades the pass characteristic indicated by the scattering parameter S21 when it is assumed that a port 1 exists on the waveguide 10 side and a port 2 exists on the signal line 24 side, is determined according to the length of a straight line L₁″ illustrated in FIG. 29.

The straight line L₁″ is a straight line that is drawn from a point P₁″ at which a center line l_{c}″ that vertically divides the long sides l₁″ and l₂″ into two equal parts intersects with the side l_{c1} of the protruding portion 25Bc that is parallel with the long side l₁″ at the top of FIG. 29 to a point P₂″ at which a short side l₃″ intersects with the long side l₂″. Also, the straight line L₁″ is a straight line that is drawn from the intersection point P₁″ to a point P₅″ at which a short side l₄″ intersects with the long side l₂″.

Next, the center frequency of an active frequency band in the waveguide converter 4 that includes the conductor patch 25B, i.e., a resonance frequency that degrades the reflection characteristic indicated by scattering parameters S11 and S22, is determined according to the length of a straight line L₂″.

The straight line L₂″ is a straight line that is drawn from a point P₃″ at which the center line l_{c}″ intersects with the long side l₂″ at the bottom of FIG. 29 to a point P₄″ at which the long side l₁″ at the top of FIG. 29 intersects with the short side l₃″. Also, the straight line L₂″ is a straight line that is drawn from the intersection point P₃″ to a point P₆″ at which the long side l₁″ at the top of FIG. 29 intersects with the short side l₄″.

As illustrated in FIG. 29, the protruding portion 25Bc is provided for the conductor patch 25B according to the second embodiment so as to touch the center of the long side l₁″. Accordingly, it becomes possible to make the straight line L1″ that determines an undesired resonance frequency be longer than the straight line L2″ that determines the center frequency of an active frequency band due to the existence of the protruding portion 25Bc. When the straight line L₁″ is made longer than the straight line L₂″, it is possible to shift an undesired resonance frequency to a high frequency, and thus it becomes possible to keep an undesired resonance frequency away from the center frequency of an active frequency band.

Accordingly, the waveguide converter 4 that is provided with the conductor patch 25B according to the second embodiment may achieve good signal conversion performance in an active frequency band. Moreover, it is possible to secure good signal conversion performance in the active frequency band even if a pattern misalignment is caused when a waveguide converter is manufactured because it is possible to keep an undesired resonance frequency away from the center frequency of an active frequency band.

Furthermore, the conductor patch 25B according to the second embodiment is formed in such a manner that the length of the short sides and long sides of the rectangular section 25Br excluding the protruding portion 25Bc becomes shorter than the length of the short sides and long sides of the conductor patch 25r of FIG. 4. In other words, when the center frequency of an active frequency band is the same between the waveguide converter 4 provided with the conductor patch 25B and the waveguide converter provided with the conductor patch 25r, the long sides l₁″ and l₂″ are shorter than the long sides l₁ and l₂, the short sides l₃″ and l₄″ are shorter than the short sides l₃ and l₄, and the size of the rectangular section 25Br is smaller than the size of the conductor patch 25r. The center frequency of an active frequency band is moved as the shape of a conductor patch becomes no longer rectangular due to the provision of the protruding portion 25Bc, and thus it becomes necessary to adjust the length of L₂′. For this reason, the size of the conductor patch 25B is smaller than the size of the conductor patch 25r as described above.

As described above in the first embodiment, the shape and size of the conductor patch 25B according to the second embodiment may be determined by using an electromagnetic field simulation.

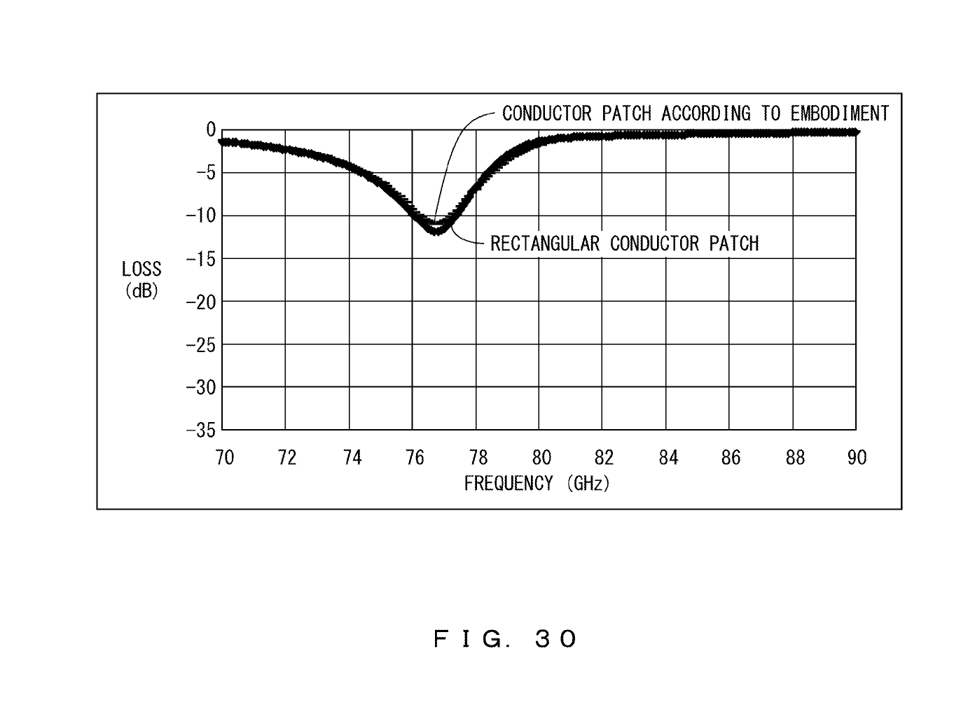

An example of the result of electromagnetic field simulation in which the signal conversion performance of the waveguide converter 4 that includes the conductor patch 25B according to the second embodiment is compared with the signal conversion performance of the waveguide converter that includes the rectangular conductor patch 25r of FIG. 4 instead of the conductor patch 25B is depicted in FIGS. 30 to 32.

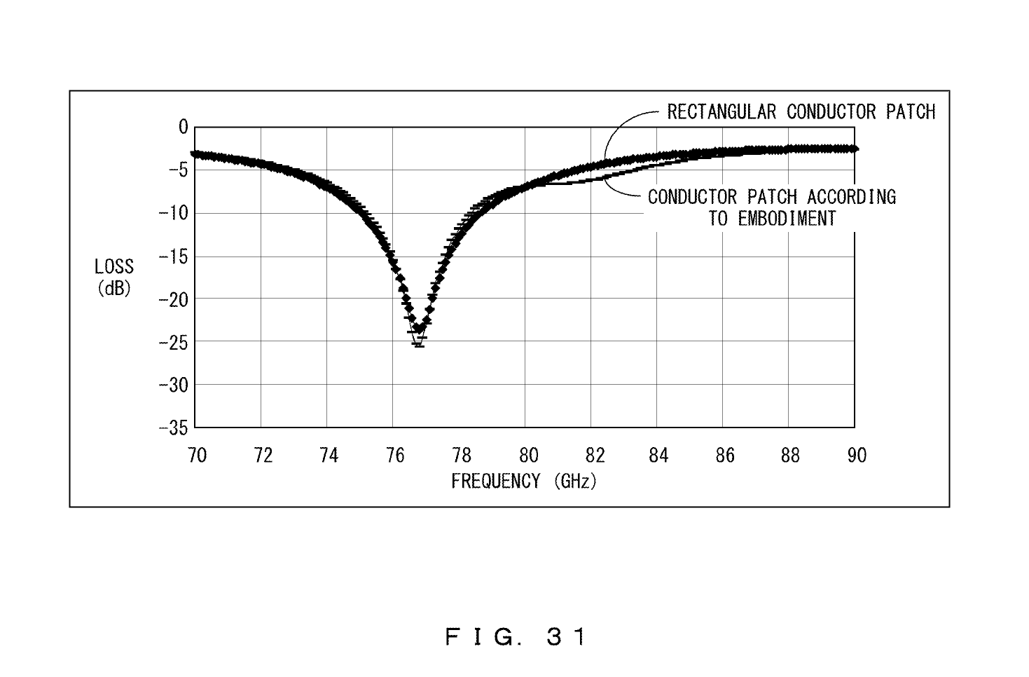

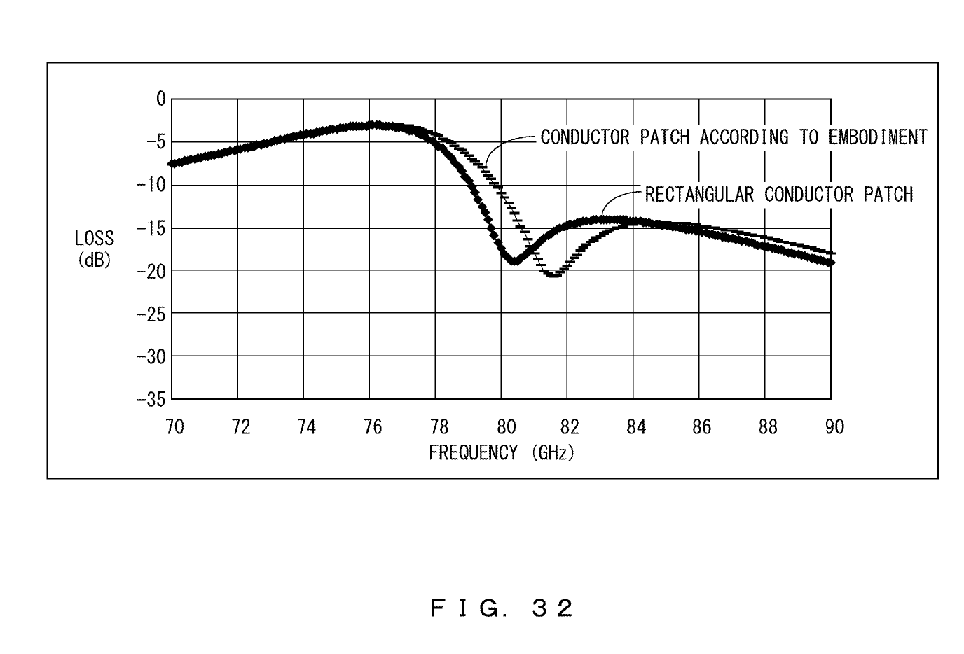

FIG. 30 depicts a simulation result of the reflection characteristic S11 of the waveguide converter that includes the conductor patch according to the second embodiment or the waveguide converter that includes a rectangular patch. FIG. 31 depicts a simulation result of the reflection characteristic S22 of the waveguide converter that includes the conductor patch according to the second embodiment or the waveguide converter that includes a rectangular patch. FIG. 32 depicts a simulation result of the pass characteristic S21 of the waveguide converter that includes the conductor patch according to the second embodiment or the waveguide converter that includes a rectangular patch.

As illustrated in FIG. 30, when the center frequency of an active frequency band, i.e., a resonance frequency of the reflection characteristic S11, is matched to 76.8 (GHz), the reflection characteristic S11 of the waveguide converter 4 that includes the conductor patch 25B according to the second embodiment may obtain almost the same frequency characteristic as the reflection characteristic of a waveguide converter that includes the rectangular conductor patch 25r. Moreover, as illustrated in FIG. 31, when a resonance frequency of the reflection characteristic S22 is matched to 76.8 (GHz), the reflection characteristic S22 of the waveguide converter 4 that includes conductor patch 25B according to the second embodiment may obtain almost the same frequency characteristic as the reflection characteristic of a waveguide converter that includes the rectangular conductor patch 25r.

Further, as illustrated in FIG. 32, when a resonance frequency of the reflection characteristic S22 is matched to 76.8 (GHz), it becomes possible for the waveguide converter 4 that includes the conductor patch 25B according to the second embodiment to keep a resonance frequency that impairs the pass characteristic S21 further away from resonance frequencies of the reflection characteristic S11 and S22 than a waveguide converter that includes the rectangular conductor patch 25r.

Moreover, it becomes possible for the waveguide converter 4 that includes a conductor patch 25B according to the second embodiment to further broaden a frequency band of the pass characteristic S21 where the loss becomes −8 (dB) than a waveguide converter that includes the rectangular conductor patch 25r.

As described above, the waveguide converter 4 that includes conductor patch 25B according to the second embodiment has a broader active frequency band that is allowed in the actual use than that of the waveguide converter that includes the rectangular conductor patch 25r. Moreover, the waveguide converter 4 that includes conductor patch 25B according to the second embodiment may keep a resonance frequency that degrades the pass characteristic further away from the center frequency of an active frequency band than the waveguide converter that includes the rectangular conductor patch 25r.

Accordingly, the waveguide converter according to the second embodiment may broaden the active frequency band at the design stage, and may keep a resonance frequency that degrades the pass characteristic away from the center frequency of an active frequency. As a result, even if a resonance frequency that degrades the pass characteristic deviates, for example, due to the variation in dimension and alignment caused when the waveguide converter is manufactured, a deterioration in the pass characteristic may be minimized, and a required signal conversion performance may be secured. As it is possible to secure a required signal conversion performance without requiring a high accuracy in manufacturing, the required accuracy in manufacturing of a waveguide converter is not necessarily very high, and a cost reduction in waveguide converters may be realized.

Further, according to the second embodiment, simulation analysis is performed as described above in regard to the first embodiment, and thereby an appropriate shape and size of the conductor patch 25B may be determined in view of not only the pass characteristic S21 but also the reflection characteristic S11 and S22.

Note that as described above, the shape and size of the conductor patch according to the second embodiment is not limited to the shape and size illustrated in FIGS. 27 to 29. For example, the shape of the protruding portion 25Bc is not necessarily rectangular, but may be polygonal or circular.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A waveguide converter comprising:
a waveguide which includes a hollow section through which a signal is transmitted and a first opening formed on a cross section of the hollow section in a direction orthogonal to a transmission direction of the signal; and
a circuit board which includes on a same surface a signal line, a conductor patch connected to the signal line, and a second opening surrounding the conductor patch, the waveguide being adhered and fixed onto the circuit board in such a manner that the first opening surrounds the second opening, wherein
the conductor patch includes a rectangular section and protruding portions,
the rectangular section has short sides in a direction parallel to short sides of the first opening, and has a first long side and a second long side in a direction parallel to long sides of the first opening, the second long side being connected to the signal line, and
the protruding portions are provided so as to touch the short sides near both ends of the second long side, respectively.

2. The waveguide converter according to claim 1, wherein
when a center frequency of an active frequency band in the waveguide converter matches a center frequency of an active frequency band in a waveguide converter that is provided with a rectangular conductor patch instead of the conductor patch, the short sides are shorter than short sides of the rectangular conductor patch, and the first and second long sides are shorter than long sides of the rectangular conductor patch.

3. The waveguide converter according to claim 1, wherein
the protruding portions are rectangular-shaped.

4. The waveguide converter according to claim 1, wherein
when lengths of sides of the protruding portions are equal to each other and a length of a side of the conductor patch obtained by adding up the second long side and sides of the protruding portions is fixed, each of lengths of the short sides, the first and second long sides, and the sides of the protruding portions is adjusted so as to optimize a reflection characteristic of the waveguide converter.

5. A waveguide converter comprising:
a waveguide which includes a hollow section through which a signal is transmitted and a first opening formed on a cross section of the hollow section in a direction orthogonal to a transmission direction of the signal; and
a circuit board which includes on a same surface a signal line, a conductor patch connected to the signal line, and a second opening surrounding the conductor patch, the waveguide being adhered and fixed onto the circuit board in such a manner that the first opening surrounds the second opening, wherein
the conductor patch includes a rectangular section and a protruding portion,
the rectangular section has short sides in a direction parallel to short sides of the first opening, and has a first long side and a second long side in a direction parallel to long sides of the first opening, the second long side being connected to the signal line, and
the protruding portion is provided so as to touch a center of the first long side.
